(19) United States
(12) Patent Application Publication
(10) Pub. No.: US 2017/0201773 A1
(43) Pub. Date: Jul. 13, 2017

(54) VIDEO CODING APPARATUS, VIDEO CODING METHOD, AND RECORDING MEDIUM

(71) Applicant: NEC Corporation, Minato-ku, Tokyo (JP)

(72) Inventors: Kenta TOKUMITSU, Tokyo (JP); Keiichi CHONO, Tokyo (JP)

(73) Assignee: NEC Corporation, Minato-ku, Tokyo (JP)

(21) Appl. No.: 15/314,551

(22) PCT Filed: Jun. 5, 2015
(86) PCT No.: PCT/JP2015/002837

§ 371 Date: Nov. 29, 2016

(30) Foreign Application Priority Data
Jun. 12, 2014 (JP) 2014-121635

(51) Int. Cl. H04N 19/96; H04N 19/119; H04N 19/33; H04N 19/513

(52) U.S. Cl. CPC H04N 19/96; H04N 19/513; H04N 19/119; H04N 19/33

(57) ABSTRACT

A video coding apparatus for outputting a scalable bit stream obtained by multiplexing a base layer bit stream and an enhancement layer bit stream, includes: a rectangular area generation unit configured to generate a rectangular area that is of a multiple of a CTU (Coding Tree Unit) size and includes a particular rectangular area; a determination unit configured to determine whether a CTU of a coding target is included in the rectangular area of the multiple of the CTU size; and a prediction unit configured to, when the CTU of the coding target is not included in the rectangular area of the multiple of the CTU size, divide the CTU of the coding target by a minimum number of CU blocks, and predict each of obtained CUs with a prediction signal of a zero motion vector from the base layer.

### TECHNICAL FIELD

The present invention relates to a coding control technique of a scalable coding method, and for example, relates to a video coding apparatus, a video coding method, and a recording medium using Scalable High-efficiency Video Coding (SHVC).

### BACKGROUND ART

A video coding method of a scalable coding method based on a method described in NPL 1 codes a low resolution image obtained by downsampling an input image as a Base Layer (BL). The video coding method codes the input image as an Enhancement Layer (EL). Each frame of the BL and the EL in the digitalized video is divided into Coding Tree Units (CTU). Then, in the order of raster scan, each CTU is coded.

The CTU is coded upon being divided into Coding Units (CUs) with a quad tree structure. Each CU is predicted upon being divided into Prediction Units (PUs). A prediction error of each CU is frequency transformed upon being divided into Transform Units (TUs) with a quad tree structure.

The CU is a coding unit for intra prediction, inter-frame prediction, and inter-layer prediction. Hereinafter, the intra prediction, the inter-frame prediction, and the inter-layer prediction will be explained.

The intra prediction is a prediction generated from a restructured image of a coding target frame. For example, 33 types of angle intra predictions and the like as illustrated in FIG. 15 are defined. In the angle intra prediction, restructured pixels around the coding target block are extrapolated in any of the 33 types of directions as illustrated in FIG. 15, so that an intra prediction signal is generated. Hereinafter, a CU coded based on the intra prediction will be referred to as an intra CU.

The inter-frame prediction is a prediction based on an image of a restructured frame (reference picture) of which display time is different from the coding target frame. Hereinafter, the inter-frame prediction may also be referred to inter prediction. FIG. 16 is an illustration for illustrating an example of an inter-frame prediction. A motion vector MV=(mvₓ, mv_{y}) indicates a parallel movement quantity of a restructured image block in the reference picture with respect to the coding target block. In the inter prediction, an inter prediction signal is generated based on the restructured image block of the reference picture (if necessary, by using pixel interpolation).

There are two types of predictions of the motion vector, i.e., AMVP (Advanced Motion Vector Prediction) and a merge mode. The AMVP is a technique for predicting a motion vector so as to achieve the least difference of the motion vector by using the motion vector of the reference picture. In the AMVP, a combination of a reference picture index, an AMVP index associated with an AMVP prediction motion vector, and the AMVP prediction motion vector are transmitted. The merge mode is a technique for using a motion vector of a reference picture as it is. In the merge mode, a combination of a merge flag indicating that the merge prediction is effective and a merge candidate index associated with the motion vector to be used is transmitted.

The inter-layer prediction is an inter prediction using an upsample image of the restructured frame of the coded BL. FIG. 17 is an illustration for illustrating inter-layer prediction. In the inter-layer prediction, a restructured frame of the coded BL is upsampled to the same resolution as a frame of the EL, so that an inter-layer prediction signal is generated.

Hereinafter, a CU coded based on the inter prediction or the inter-layer prediction is referred to as an inter CU.

A frame coded with only intra CU is referred to as an I frame (or an I picture). A frame coded to include not only the intra CU but also the inter CU is referred to as a P frame (or P picture). A frame coded to include an inter CU using not only a single reference picture but also two reference pictures at a time for inter prediction of a block is called a B frame (or B picture).

Subsequently, a configuration and an operation of a generally-available video coding apparatus outputting a bit stream by using each CTU of each frame of a digitalized video as an input image will be explained with reference to FIG. 18.

A video coding apparatus as illustrated in FIG. 18 includes a BL coding device 900A for coding a BL, an EL coding device 900B for coding an EL, a downsample device 909, and a multiplexer 910.

The BL coding device 900A includes an estimation device 901A, a prediction device 902A, a frequency transform device 903A, a quantization device 904A, an inverse frequency transform/inverse quantization device 905A, a buffer 906A, and an entropy coding device 907A.

The EL coding device 900B includes an estimation device 901B, a prediction device 902B, a frequency transform device 903B, a quantization device 904B, an inverse frequency transform/inverse quantization device 905B, a buffer 906B, an entropy coding device 907B, and an upsample device 908.

Hereinafter, a configuration and an operation of the BL coding device 900A and the EL coding device 900B will be explained.

Each CTU of each of the EL and the BL that are input into the BL coding device 900A and the EL coding device 900B, respectively, is divided based on a quad tree structure into CUs having variable sizes. In a case where the CTU is not divided, the CTU is simply adopted as a CU, and accordingly, the size of the CTU is the maximum size of the CU (maxCUSize). The CU having the maximum size and the CU having the minimum size are referred to as an LCU (Largest Coding Unit, maximum coding unit) and an SCU (Smallest Coding Unit, minimum coding unit), respectively.

FIG. 19 is an illustration for illustrating a CTU division example of the t-th frame and an example of CU divisions of the eighth CTU (CTU 8) in a case where the space resolution of a frame is a CIF (Common Intermediate Format), and the CTU size is 64. A number attached to a CU in FIG. 19 denotes a sequence of processing of the CU. In the following explanation, the t-th frame may also be referred to as a frame t.

FIG. 20 is an illustration for illustrating a layered block expression and a quad tree structure corresponding to the CU division example of the CTU 8. A CU Depth in the layered block expression as illustrated in FIG. 20 indicates the depth of the division layer of the CU with the CTU being the starting point. The video coding apparatus transmits split_cu_flag syntax indicating whether a CU is to be divided or not in order to signal (i.e., transmit a signal from the encoder to the decoder) the CU division structure of the CTU. A value (0 or 1) of a node of the quad tree in the quad tree structure corresponds to the value of split_cu_flag.

FIG. 21 is an illustration for illustrating an example of a PU division of a CU. In FIG. 21, N is a variable representing a size. In a case of an intra CU, the form of the divides PUs (which may also be referred to as PU division form) include two patterns, i.e., 2N×2N and N×N. In a case of an inter CU, the PU division form include eight patterns, i.e., 2N×2N, 2N×N, N×2N, N×N, 2N×nU, 2N×nD, nL×2N, and nR×2N. In FIG. 21, n denotes any given number, and U, D, L, and R denote variables indicating any given size. A number attached to a PU in FIG. 21 indicates the sequence of processing of the PU. In a case of a PU division of CU, the video coding apparatus transmits a parameter (block division form) indicating which of intra prediction, inter prediction, and inter-layer prediction is selected, and which division pattern is selected. In addition, the video coding apparatus transmits a parameter based on AMVP or merge mode. The information indicating which of predictions, i.e., intra prediction, inter prediction, and inter-layer prediction, has been selected, the block division form, and the parameter based on AMVP or merge mode will be collectively referred to as a block division/block prediction parameter, or simply referred to as a block prediction parameter.

Like the CTU, the prediction error of each CU is divided into TUs having variable sizes based on the quad tree structure.

FIG. 22 is an illustration for illustrating a TU division example in a case of inter CU, and illustrating a layered block expression and a quad tree structure corresponding to this TU division example. The parent node position of the quad tree structure of the TU is a CU. Accordingly, a transform coding can be performed over multiple PUs in the same CU. The TU Depth in the layered block expression as illustrated in FIG. 22 indicates the depth of a division layer of a TU with the CU being the starting point. The video coding apparatus transmits split_transform_flag syntax indicating whether a TU is to be divided or not in order to signal the TU division structure of the CU. A value (0 or 1) of a node of the quad tree in the quad tree structure corresponds to the value of split_transform_flag.

FIG. 23 is an illustration for illustrating a TU division example in a case of intra CU, and illustrates a layered block expression and a quad tree structure corresponding to this TU division example. The parent node position of the quad tree structure of the TU is a PU, and like the inter CU, it is divided into TUs.

For each CTU of a low resolution image obtained when the downsample device 909 downsamples the input image, the estimation device 901A determines a CU quad tree structure, a block prediction parameter of a PU (hereinafter referred to as a PU block prediction parameter), and a TU quad tree structure.

The prediction device 902A generates a prediction signal for the input image signal of the CU based on the CU quad tree structure and the PU block prediction parameter determined by the estimation device 901A. The prediction signal is generated based on the intra prediction or the inter prediction described above.

The frequency transform device 903A performs frequency transform on a prediction error signal (hereinafter referred to as a prediction error image) obtained by subtracting the prediction signal from the input image signal based on the TU quad tree structure determined by the estimation device 901A.

The quantization device 904A quantizes orthogonal transform coefficients (the frequency-transformed prediction error image). Hereinafter, the quantized orthogonal transform coefficients will be referred to as coefficient levels. A coefficient level having a value other than zero will be referred to as a significant coefficient level.

The entropy coding device 907A performs entropy coding of split_cu_flag indicating the CU quad tree structure of the CTU unit, the PU block prediction parameter, split_transform_flag indicating the quad tree structure of the TU, and the coefficient levels. The parameter group which is coded with entropy coding will be referred to as coding parameters.

The inverse frequency transform/inverse quantization device 905A performs inverse quantization of the coefficient levels. Further, the inverse frequency transform/inverse quantization device 905A performs inverse frequency transform on the inversely quantized orthogonal transform coefficients. The prediction signal is added to the restructured prediction error image transformed with the inverse frequency transform, and the restructured prediction error image is provided to the buffer 906A as a restructured image.

The buffer 906A stores the restructured image. The restructured image stored in the buffer 906A is obtained by the estimation device 901A and the prediction device 902A to be used for determination of the CU quad tree structure, the PU block prediction parameter, and the TU quad tree structure and generation of the prediction signal.

For each CTU of the input image, the estimation device 901B determines the CU quad tree structure, the PU block prediction parameter, and the TU quad tree structure.

The prediction device 902B generates a prediction signal for the input image signal of the CU based on the CU quad tree structure and PU block prediction parameter determined by the estimation device 901B. The prediction signal is generated based on the intra prediction, the inter prediction, or the inter-layer prediction described above.

The frequency transform device 903B performs frequency transform of the prediction error image obtained by subtracting the prediction signal from the input image signal, based on the TU quad tree structure determined by the estimation device 901B.

The quantization device 904B quantizes the orthogonal transform coefficients (the frequency-transformed prediction error image).

The entropy coding device 907B performs the entropy coding on split_cu_flag indicating the quad tree structure of the CU, the PU block prediction parameter, split_transform_flag indicating the quad tree structure of the TU, and the coefficient levels.

The inverse frequency transform/inverse quantization device 905B performs inverse quantization on the coefficient levels. Further, the inverse frequency transform/inverse quantization device 905B performs inverse frequency transform the inversely quantized orthogonal transform coefficients. The prediction signal is added to the restructured prediction error image transformed with the inverse frequency transformed, and the restructured prediction error image is provided to the buffer 906B as a restructured image.

The buffer 906B stores the restructured image. The buffer 906B also stores an image obtained when the upsample device 908 upsamples the restructured image of the BL. The data stored in the buffer 906B is obtained by the estimation device 901B and the prediction device 902B to be used for determination of the CU quad tree structure, the PU block prediction parameter, and the TU quad tree structure, and generation of the prediction signal.

Based on the above operation, a BL bit stream which is a sub-bit stream is generated in the BL coding device 900A. An EL bit stream which is a sub-bit stream is generated in the EL coding device 900B. In a generally-available video coding apparatus, these sub-bit streams are multiplexed by the multiplexer 910, so that a scalable bit stream is generated.

PTL 1 describes a moving image coding apparatus for optimizing a coding efficiency and a prediction efficiency. In a case where a motion of a processing target block makes a uniform motion with respect to a reference image of any one of reference images in LX direction and a reference image of any one of reference images in LY direction, the apparatus described in PTL 1 scales motion information in a single direction to generate a scaling combined motion information candidate when the same uniform motion as the processing target block is made only in a single direction of L0 direction or L1 direction in motion information of the same position block of another coded image and an adjacent block of the processing target block, so that the apparatus can perform coding with only a merge index without coding the motion information.

### CITATION LIST

### Patent Literature

PTL 1: Japanese Patent Application Laid-Open Publication No. 2013-021573

### Non Patent Literature

NPL 1: High efficiency video coding (HEVC) scalable extension Draft 4, JCTVC-01008_v3, Joint Collaborative Team on Video Coding (JCT-VC) of ITU-T SG16 WP3 and ISO/IEC JTC1/SC29/WG11 15th Meeting: Geneva, CH, 23 October-1 November 2013.

### SUMMARY OF INVENTION

### Technical Problem

When a generally-available video coding apparatus described in the background art tries to switch a preferable compression processing for an area where compression is performed by giving precedence to an image quality (which may also be referred to as an image quality preferential compression area) and an area where compression is performed by giving precedence to the number of bits (which may also be referred to as the bit number preferential compression area), there is an increase in the amount of computation for making a determination for switching the compression processing and performing the CTU division control. In this case, the image quality is, for example, a space resolution.

When the compression is performed by giving precedence to only the number of bits, there is no guarantee that the inter-layer prediction is selected, and therefore, it is not guaranteed to reduce the amount of computation required for estimating the coding parameters and maintain the lowest image quality of the entire screen to a certain level. In this case, the lowest image quality is the image quality of the low resolution image.

Further, when a prediction error having a large power occurs in an area where the compression is performed by giving precedence to the number of bits, the number of bits greatly increases. Therefore, it is impossible to compress an image quality preferential area designated by the user with a high image quality by making use of the number of bits saved in the area where the compression is performed by giving precedence to the number of bits.

For this reason, the generally-available video coding apparatus is unable to compress an image quality preferential area designated by the user with a high image quality while maintaining the lowest image quality of the entire screen to a certain level without increasing the amount of computation.

Accordingly, it is an object of the present invention to provide a video coding apparatus, a video coding method, and a recording medium storing a video coding program capable of compressing an image quality preferential area designated by the user with a high image quality while maintaining the lowest image quality of the entire screen to a certain level without increasing the amount of computation.

### Solution to Problem

A video coding apparatus according to one aspect of the present invention for outputting a scalable bit stream obtained by multiplexing a base layer bit stream in which a low resolution image obtained by downsampling an input image is coded as a base layer and an enhancement layer bit stream in which the input image is coded as an enhancement layer, includes: rectangular area generation means for generating a rectangular area that is of a multiple of a CTU size and includes a particular rectangular area; determination means for determining whether a CTU of a coding target is included in the rectangular area of the multiple of the CTU size; and prediction means for, when the CTU of the coding target is not included in the rectangular area of the multiple of the CTU size, dividing the CTU of the coding target by a minimum number of CU blocks, and predicting each of obtained CUs with a prediction signal of a zero motion vector from the base layer.

A video transmission and reception system according to one aspect of the present invention includes: a video coding apparatus for outputting a scalable bit stream obtained by multiplexing a base layer bit stream in which a low resolution image obtained by downsampling an input image is coded as a base layer and an enhancement layer bit stream in which the input image is coded as an enhancement layer; a video decoding apparatus for receiving and decoding the scalable bit stream which is output from the video coding apparatus; and image generation unit configured to generate an image including a decoded image and rectangular area information indicating a particular rectangular area, wherein the video coding apparatus includes: rectangular area generation means for generating a rectangular area that is of a multiple of a CTU size and includes a particular rectangular area; determination means for determining whether a CTU of a coding target is included in the rectangular area of the multiple of the CTU size; and prediction means for, when the CTU of the coding target is not included in the rectangular area of the multiple of the CTU size, dividing the CTU of the coding target by a minimum number of CU blocks, and predicting each of obtained CUs with a prediction signal of a zero motion vector from the base layer.

A display video generation apparatus according to one aspect of the present invention generating a video to be displayed based on a decoded video and rectangular area information of a scalable bit stream, includes a video decoding apparatus; and image generation unit, wherein when a user designates a normal display, the video decoding apparatus decodes a base layer bit stream from the scalable bit stream, and the image generation unit generates a video to be displayed of the base layer bit stream enlarged to a display size, wherein when the user designates detailed display, the video decoding apparatus decodes the base layer bit stream and the enhancement layer bit stream including the rectangular area from the scalable bit stream, and the image generation unit generates a decoded video of the base layer bit stream and a decoded video of the enhancement layer bit stream including the rectangular area, and wherein when the user designates rectangular area display, the image generation unit superimposes the rectangular area on the decoded video.

A video coding method according to one aspect of the present invention, in a video coding apparatus for outputting a scalable bit stream obtained by multiplexing a base layer bit stream in which a low resolution image obtained by downsampling an input image is coded as a base layer and an enhancement layer bit stream in which the input image is coded as an enhancement layer, includes: generating a rectangular area that is of a multiple of a CTU size, including a particular rectangular area; determining whether a CTU of a coding target is included in the rectangular area of the multiple of the CTU size; and when the CTU of the coding target is not included in the rectangular area of the multiple of the CTU size, dividing the CTU of the coding target by a minimum number of CU blocks, and predicting each of obtained CUs with a prediction signal of a zero motion vector from the base layer.

A computer-readable recording medium stores a video coding program for a computer in a video coding apparatus for outputting a scalable bit stream obtained by multiplexing a base layer bit stream in which a low resolution image obtained by downsampling an input image is coded as a base layer and an enhancement layer bit stream in which the input image is coded as an enhancement layer, wherein the video coding program causing the computer to execute: processing of generating a rectangular area, that is of a multiple of a CTU size, including a particular rectangular area; processing of determining whether a CTU of a coding target is included in the rectangular area of the multiple of the CTU size; and processing of, when the CTU of the coding target is not included in the rectangular area of the multiple of the CTU size, dividing the CTU of the coding target by a minimum number of CU blocks, and predicting each of obtained CUs with a prediction signal of a zero motion vector from the base layer.

### Advantageous Effects of Invention

According to the present invention, an image quality preferential area designated by the user can be compressed with a high image quality while maintaining the lowest image quality of the entire screen to a certain level without increasing the amount of computation.

### BRIEF DESCRIPTION OF DRAWINGS

FIG. 1 is a block diagram illustrating an example of a configuration of a video coding apparatus according to a first exemplary embodiment of the present invention.

FIG. 2 is a flowchart illustrating an operation of an EL coding device according to the first exemplary embodiment of the present invention.

FIG. 3 is a block diagram illustrating an example of a configuration of a video coding apparatus according to a second exemplary embodiment of the present invention.

FIG. 4 is a flowchart illustrating an operation of an AMVP estimation device according to the second exemplary embodiment of the present invention.

FIG. 5 is a block diagram illustrating an example of a configuration of a video coding apparatus according to a third exemplary embodiment of the present invention.

FIG. 6 is a flowchart illustrating an operation of a merge prediction estimation device according to the third exemplary embodiment of the present invention.

FIG. 7 is a block diagram illustrating an example of a configuration of a video coding apparatus according to a fourth exemplary embodiment of the present invention.

FIG. 8 is a flowchart illustrating an operation of an EL coding device according to the fourth exemplary embodiment of the present invention.

FIG. 9 is a block diagram illustrating an example of a configuration of a video transmission and reception system according to a fifth exemplary embodiment of the present invention.

FIG. 10 is a block diagram illustrating an example of a configuration of a display video generation apparatus according to a sixth exemplary embodiment of the present invention.

FIG. 11 is a block diagram illustrating an example of an information processing system using a program.

FIG. 12 is a block diagram illustrating a main portion of a video coding apparatus according to each exemplary embodiment of the present invention.

FIG. 13 is a block diagram illustrating a main portion of another video coding apparatus according to the present invention.

FIG. 14 is a block diagram illustrating a main portion of a video transmission and reception system according to the present invention.

FIG. 15 is an illustration illustrating an example of 33 types of an angle intra prediction.

FIG. 16 is an illustration for illustrating an example of inter-frame prediction.

FIG. 17 is an illustration for illustrating inter-layer prediction.

FIG. 18 is a block diagram illustrating a configuration of a generally-available video coding apparatus.

FIG. 19 is an illustration for illustrating a CTU division example of a frame t, and an example of a CU division of a CTU 8 of the frame t.

FIG. 20 is an illustration for illustrating a layered block expression and a quad tree structure corresponding to the CU division example of the CTU 8.

FIG. 21 is an illustration for illustrating an example of a PU division of a CU.

FIG. 22 is an illustration for illustrating a TU division example in a case of inter CU and a layered block expression and a quad tree structure corresponding to this TU division example.

FIG. 23 is an illustration for illustrating a TU division example in a case of intra CU, and a layered block expression and quad tree structure corresponding to this TU division example.

### DESCRIPTION OF EMBODIMENTS

### First Exemplary Embodiment

The first exemplary embodiment of the present invention will be hereinafter explained with reference to drawings.

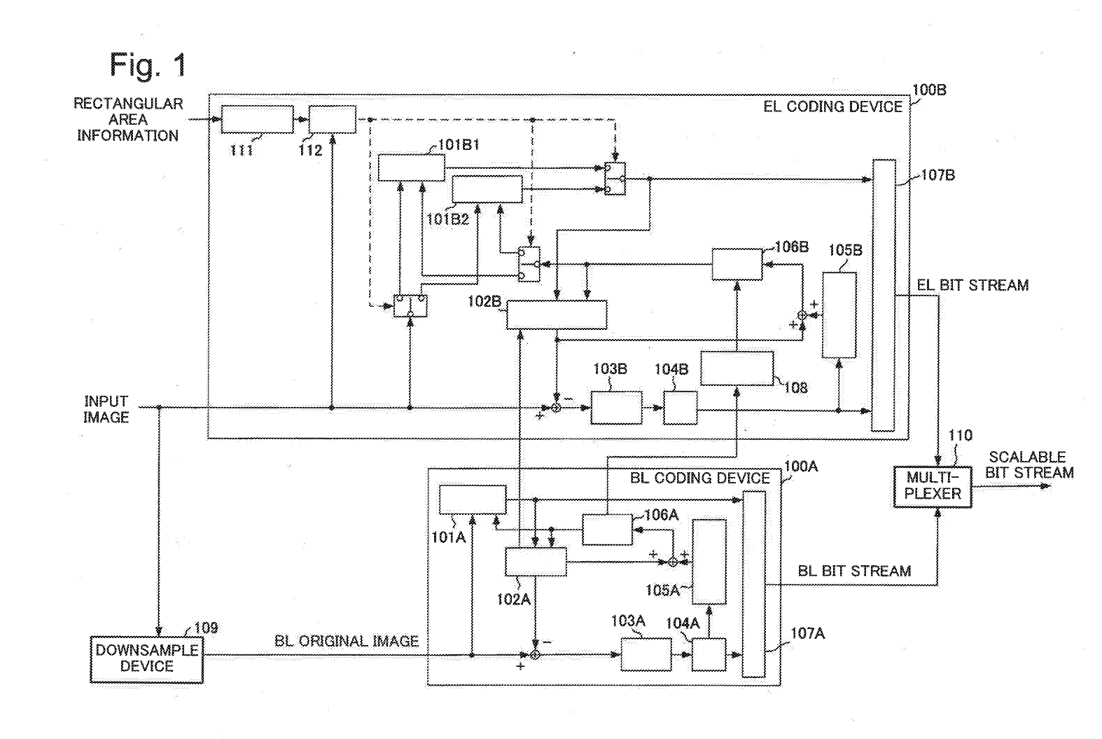

FIG. 1 is a block diagram illustrating an example of a configuration of a video coding apparatus according to the first exemplary embodiment of the present invention. A configuration of a video coding apparatus according to the first exemplary embodiment using each frame of a digitalized video as an input image to output a bit stream will be explained with reference to FIG. 1.

The video coding apparatus according to the first exemplary embodiment uses a CTU align coordinate transform device 111 explained later to generate a rectangular area which is of a multiple of a CTU size and which includes a rectangular area (particular rectangular area) designated from an outside of the apparatus. Accordingly, a determination between an area where compression is performed by giving precedence to the image quality and an area where compression is performed by giving precedence to the number of bits becomes a CTU unit, and a switching control of compression processing preferable for each area is simplified. Further, block division/block prediction parameters in the area where the compression is performed by giving precedence to the number of bits are determined by a bit number preferential estimation device 101B2 explained later. Therefore, a coding parameter for the minimum number of bits using the base layer is uniquely selected, and further, while the image quality is maintained at a certain level, the amount of computation required for estimation of the coding parameter is greatly reduced. As a result, the area where the compression is performed by giving precedence to the image quality can be compressed with a higher image quality by effectively making use of the number of bits and the amount of computation that were saved in the area where the compression is performed by giving precedence to the number of bits.

The video coding apparatus as illustrated in FIG. 1 includes a BL coding device 100A for coding a BL, an EL coding device 100B for codling an EL, a downsample device 109, and a multiplexer 110. The BL coding device 100A is, for example, a BL HEVC encoder. The EL coding device 100B is, for example, an EL HEVC encoder.

The BL coding device 100A includes an estimation device 101A, a prediction device 102A, a frequency transform device 103A, a quantization device 104A, an inverse frequency transform/inverse quantization device 105A, a buffer 106A, and an entropy coding device 107A.

The EL coding device 100B includes a prediction device 102B, a frequency transform device 103B, a quantization device 104B, an inverse frequency transform/inverse quantization device 105B, a buffer 106B, an entropy coding device 107B, an upsample device 108, a CTU align coordinate transform device 111, a CTU determination device 112, an image quality preferential estimation device 101B1, and a bit number preferential estimation device 101B2.

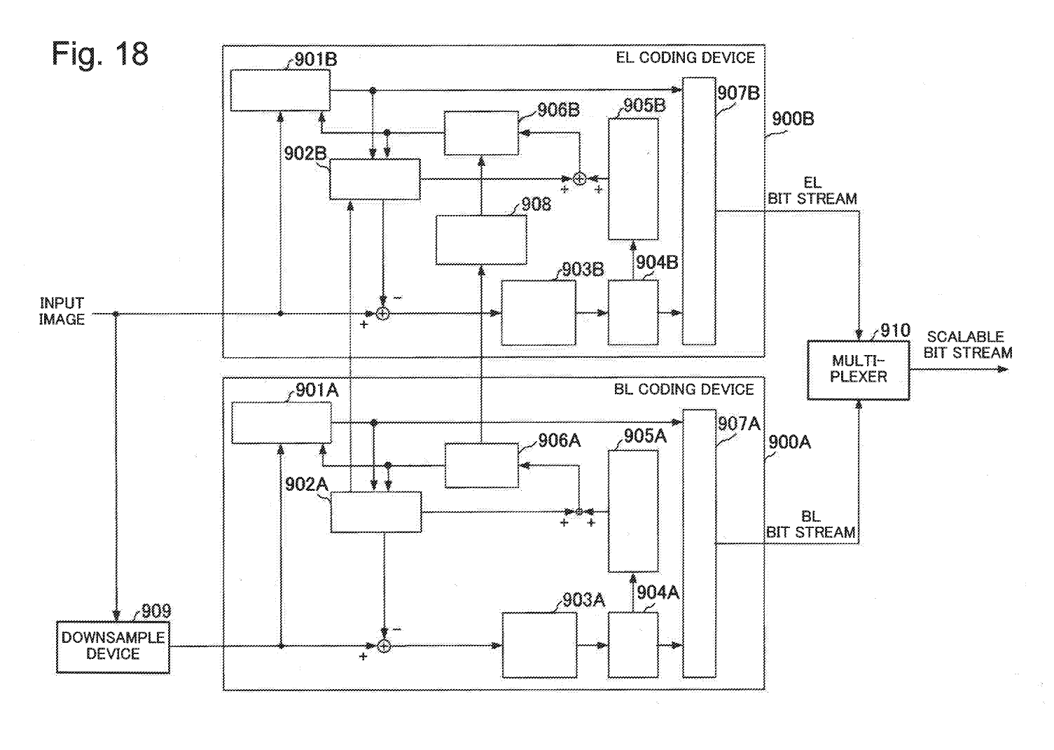

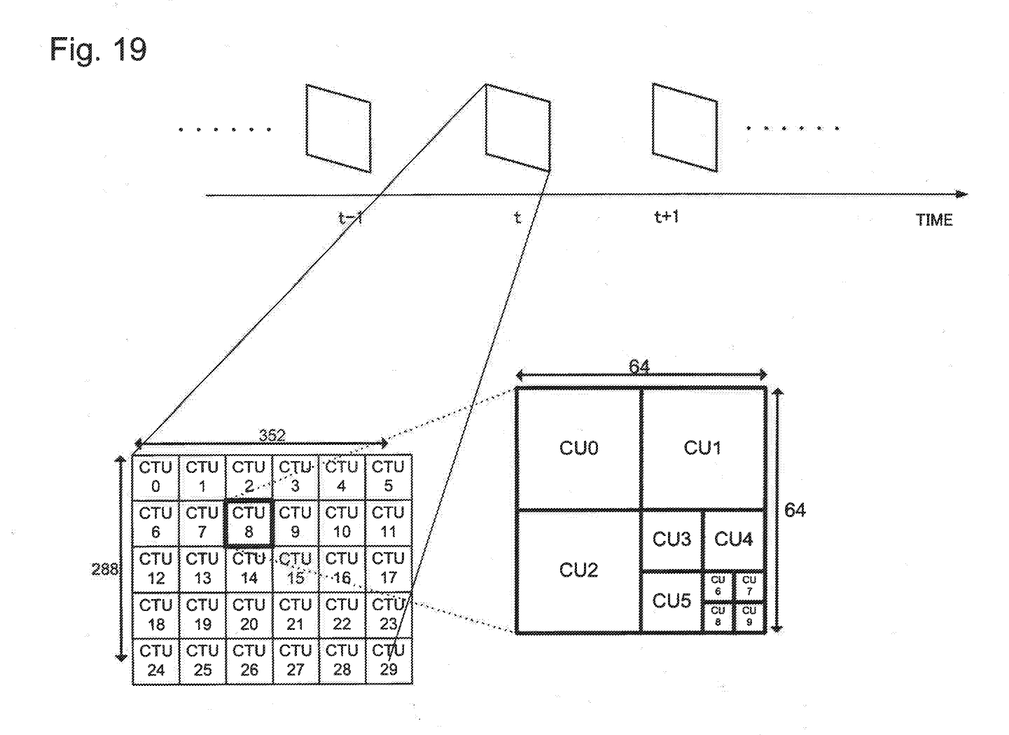

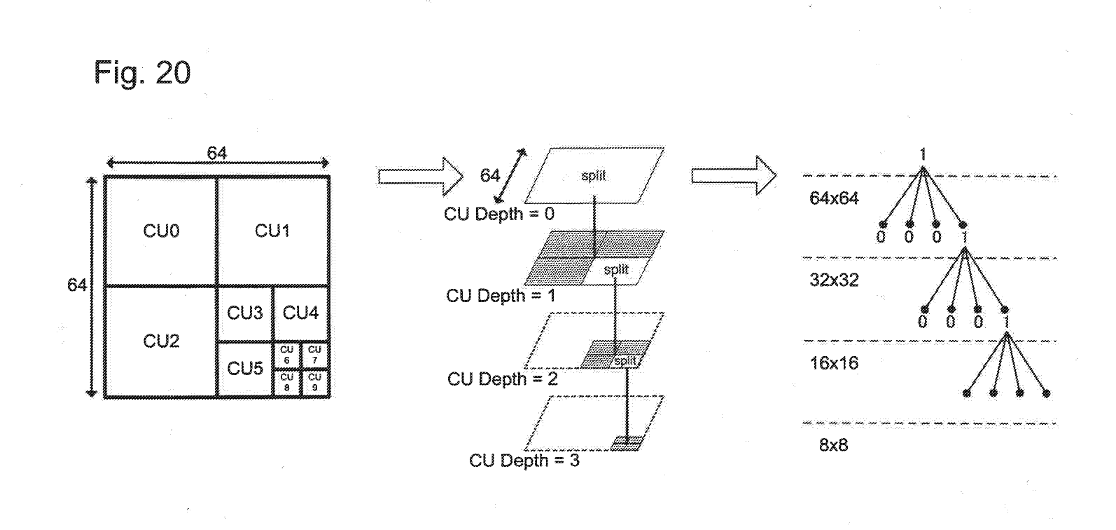

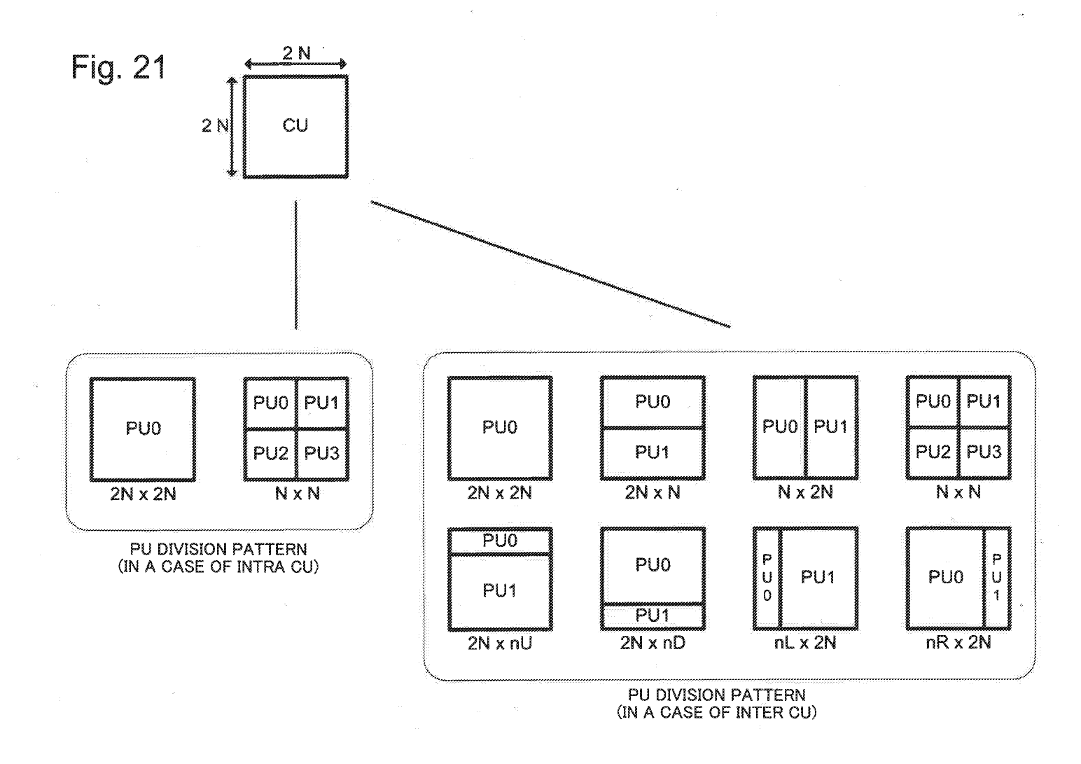

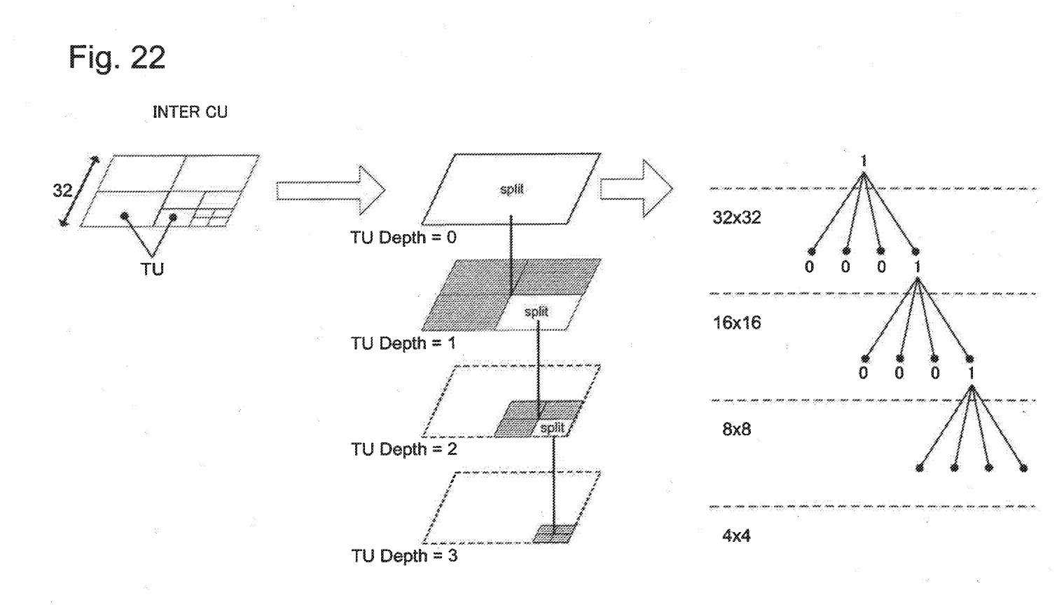

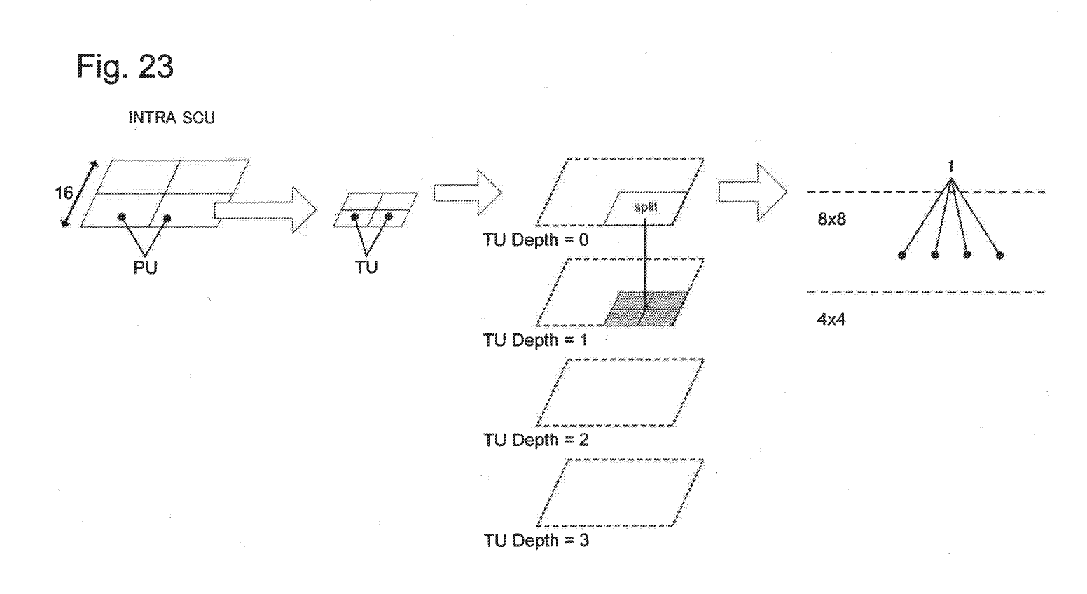

As compared with the video coding apparatus as shown in FIG. 18, the EL coding device 100B is provided with the CTU align coordinate transform device 111, the CTU determination device 112, the image quality preferential estimation device 101B1, and the bit number preferential estimation device 101B2. The other blocks in the video coding apparatus as illustrated in FIG. 1 are the same as the blocks of the video coding apparatus as illustrated in FIG. 18. Therefore, the configuration of the EL coding device 100B, which is a characteristic portion of the present exemplary embodiment, will be hereinafter explained.

The CTU align coordinate transform device 111 receives, as input, an upper left (x, y) coordinate and a lower right (x, y) coordinate of a rectangular area designated by the user as an image quality preferential area (which will be hereinafter referred to as rectangular area information), and outputs the image quality preferential compression area. More specifically, the CTU align coordinate transform device 111 outputs, as an image quality preferential compression area, an upper left (x, y) coordinate and a lower right (x, y) coordinate including the image quality preferential area designated by the user and adjusted to a multiple of the maximum size of the CTU. For example, when the CTU is a multiple of 64, and the user inputs an upper left coordinate (x, y)=(4, 40) and a lower right coordinate (x, y)=(480, 320), the CTU align coordinate transform device 111 converts the input coordinates into an upper left coordinate (0, 0) and lower right coordinate (512, 320). Then, the CTU align coordinate transform device 111 outputs the converted coordinates. More specifically, the CTU align coordinate transform device 111 outputs the image quality preferential compression area represented by the converted coordinates.

The CTU determination device 112 receives the image quality preferential compression area which is output from the CTU align coordinate transform device 111 and the CTU of the current coding target as input. The CTU determination device 112 determines whether the CTU of the current coding target is included in the image quality preferential compression area or not, and outputs a control signal.

In a case where the CTU of the current coding target is included in the image quality preferential compression area, the CTU determination device 112 outputs a control signal for controlling switches so as to achieve (i), (ii), (iii) shown below.

(i) The image quality preferential estimation device 101B1 receives the CTU of the current coding target.

(ii) The output of the image quality preferential estimation device 101B1 is input into the prediction device 102B and the entropy coding device 107B.

(iii) The image quality preferential estimation device 101B1 can obtain, from the buffer 106B, data stored in the buffer 106B.

Then, like the generally-available video coding apparatus, the image quality preferential estimation device 101B1 determines a CU quad tree structure, a PU block prediction parameter, and a TU quad tree structure for each CTU. Like the generally-available video coding apparatus, the CU quad tree structure is determined to minimize the rate distortion cost of the CU of the CTU of the current coding target. Like the generally-available video coding apparatus, the PU block prediction parameter is determined to minimize the rate distortion cost of each CU. Further, like the generally-available video coding apparatus, the TU quad tree structure is determined to minimize the rate distortion cost of each CU.

When the CTU of the current coding target is not included in the image quality preferential compression area, the CTU determination device 112 outputs a control signal for controlling switches so as to achieve (i), (ii), (iii) shown below.

(i) The image quality preferential estimation device 101B2 receives the CTU of the current coding target.

(ii) The output of the image quality preferential estimation device 101B2 is input into the prediction device 102B and the entropy coding device 107B.

(iii) The image quality preferential estimation device 101B2 can obtain, from the buffer 106B, data stored in the buffer 106B.

The bit number preferential estimation device 101B2 determines the CU quad tree structure, the PU block prediction parameter, and the TU quad tree structure for each CTU so that the image quality of the CTU of the current coding target is maintained at a certain level, and the number of bits thereof is minimized, and further, the efficiency of the coding processing is improved.

The bit number preferential estimation device 101B2 determines the CU quad tree structure to minimize the number of CU divisions in the CTU of the current coding target. For example, when the size of the CTU is 64×64, the bit number preferential estimation device 101B2 determines that the size of the CU is a size of 64×64. More specifically, the bit number preferential estimation device 101B2 outputs split_cu_flag=0 indicating that no block division is made.

The bit number preferential estimation device 101B2 determines the PU block prediction parameter so that the number of bits in each CU is minimized. For example, the bit number preferential estimation device 101B2 determines that the division form of the PUs is 2N×2N, in which the number of divisions is small. Further, the bit number preferential estimation device 101B2 selects the inter-layer prediction of zero motion vector rather than selecting the intra prediction so as to maintain a certain image quality in each PU.

The bit number preferential estimation device 101B2 determines the TU quad tree structure so as to minimize the number of bits of the TU parameter of each CU. In other words, the bit number preferential estimation device 101B2 determines the TU parameter of the maximum size. More specifically, the bit number preferential estimation device 101B2 determines that split_transform_flag is any one of 0 and 1 in accordance with the size of each CU. For example, when the size of the CU is 64×64, the bit number preferential estimation device 101B2 determines that the TU parameter is 32×32 which is the maximum size. In other words, first, the bit number preferential estimation device 101B2 outputs split_transform_flag=1 indicating that a block division will be made, and outputs split_transform_flag=0 indicating that any block division will not be made in each TU having a size of 32×32.

The prediction device 102B outputs a prediction signal for the input image signal of the CU based on the CU quad tree structure and the PU block prediction parameter determined by the image quality preferential estimation device 101B1 or the bit number preferential estimation device 101B2. The prediction signal is generated based on the intra prediction, the inter prediction, or the inter-layer prediction described above.

The frequency transform device 103B performs frequency transform to transform the prediction error image obtained by subtracting the prediction signal from the input image signal based on the TU quad tree structure determined by the image quality preferential estimation device 101B1 or the bit number preferential estimation device 101B2. Then, the frequency transform device 103B outputs orthogonal transform coefficients (the frequency-transformed prediction error image).

The quantization device 104B quantizes the orthogonal transform coefficients. Then, the quantization device 104B outputs the coefficient levels.

The entropy coding device 107B performs entropy coding on split_cu_flag indicating the quad tree structure of the CU, the PU block prediction parameter, split_transform_flag indicating the quad tree structure of the TU, and coefficient levels. Then, the entropy coding device 107B outputs the EL bit stream.

The inverse frequency transform/inverse quantization device 105B performs inverse quantization on the coefficient levels. Then, the inverse frequency transform/inverse quantization device 105B performs inverse frequency transform on the orthogonal transform coefficients obtained through the inverse quantization, and outputs the restructured prediction error image.

The buffer 106B receives the image obtained by upsampling the restructured image of the BL and the signal obtained by adding the prediction signal to the restructured prediction error image as input, and stores them as the restructured image of the EL.

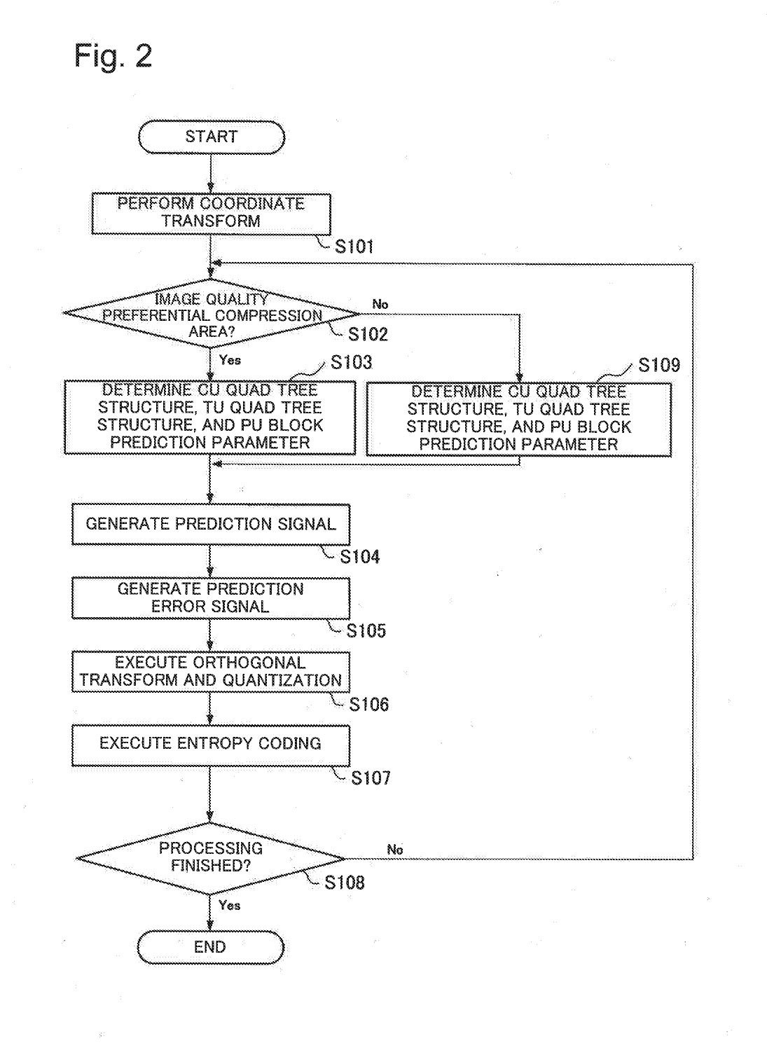

Subsequently, an operation (coding processing of the input image) of the EL coding device 100B performed on each CTU will be explained with reference to the flowchart as shown in FIG. 2.

The CTU align coordinate transform device 111 receives an upper left (x, y) coordinate and a lower right (x, y) coordinate of the rectangular area designated by the user as the image quality preferential area. Then, the CTU align coordinate transform device 111 outputs an upper left (x, y) coordinate and a lower right (x, y) coordinate including the image quality preferential area designated by the user and adjusted to a multiple of the maximum size of the CTU. For example, when the CTU is a multiple of 64, and the user inputs an upper left coordinate (x, y)=(4, 40) and a lower right coordinate (x, y)=(480, 320), the CTU align coordinate transform device 111 outputs coordinates of the upper left (0, 0) and the lower right (512, 320) (step S101). Then, the EL coding device 100B proceeds to the processing in step S102.

The CTU determination device 112 determines whether the CTU of the current coding target is included in the image quality preferential compression area or not (step S102). When the CTU of the current coding target is included in the image quality preferential compression area (Yes in step S102), the EL coding device 100B proceeds to the processing in step S103. When the CTU of the current coding target is not included in the image quality preferential compression area (No in step S102), the EL coding device 100B proceeds to the processing in step S109.

In a case of Yes in step S102, the image quality preferential estimation device 101B1 determines the CU quad tree structure, the PU block prediction parameter, and the TU quad tree structure (step S103). The CU quad tree structure is determined to minimize the rate distortion cost of the CU of the CTU of the current coding target. The PU block prediction parameter is determined to minimize the rate distortion cost of each CU. Further, the TU quad tree structure is determined to minimize the rate distortion cost of each CU. Then, the EL coding device 100B proceeds to the processing in step S104.

In a case of No in step S102, the bit number preferential estimation device 101B2 uniquely determines the CU quad tree structure, the PU block prediction parameter, and the TU quad tree structure (step S109). The CU quad tree structure is determined to minimize the number of CUs into which the CTU of the current coding target is divided. The block division form in the PU block prediction parameter is determined to minimize the number of bits of the PU parameter in each CU. Further, the bit number preferential estimation device 101B2 selects the inter-layer prediction rather than selecting the intra prediction and the inter prediction so as to maintain a certain image quality in each PU. The TU quad tree structure is determined to minimize the number of bits of the TU parameter of each CU. More specifically, the bit number preferential estimation device 101B2 selects the TU parameter of the maximum size. Then, the EL coding device 100B proceeds to the processing in step S104.

After step S103 or step S109, the prediction device 102B generates and outputs a prediction signal based on the determined PU block prediction parameter (step S104). Then, the EL coding device 100B proceeds to the processing in step S105.

The prediction error image (prediction error signal) is generated by subtracting the prediction signal from the input image signal (step S105). The prediction error image which is a difference between the input image signal and the prediction signal is input into the frequency transform device 103B. Then, the EL coding device 100B proceeds to the processing in step S106.

The frequency transform device 103B performs frequency transform on the prediction error image based on the determined TU quad tree structure. Then, the frequency transform device 103B outputs the orthogonal transform coefficients (the frequency-transformed prediction error image). The quantization device 104B quantizes the orthogonal transform coefficients, and outputs the coefficient levels (step S106). Then, the EL coding device 100B proceeds to the processing in step S107.

The entropy coding device 107B performs entropy coding on split_cu_flag indicating the quad tree structure of the CU, the PU block prediction parameter, split_transform_flag indicating the TU quad tree structure, and the coefficient levels (step S107). Then, the entropy coding device 107B outputs an EL bit stream. Then, the EL coding device 100B proceeds to the processing in step S108.

The EL coding device 100B determines whether all the CTUs included in the input image have been processed or not (step S108). When the EL coding device 100B have processed all the CTUs (Yes in step S108), the EL coding device 100B terminates the coding processing of the input image. When the EL coding device 100B have not yet processed all the CTUs (No in step S108), the EL coding device 100B proceeds to the processing in step S102 in order to process a subsequent CTU.

### Second Exemplary Embodiment

The second exemplary embodiment of the present invention will be hereinafter explained with reference drawings.

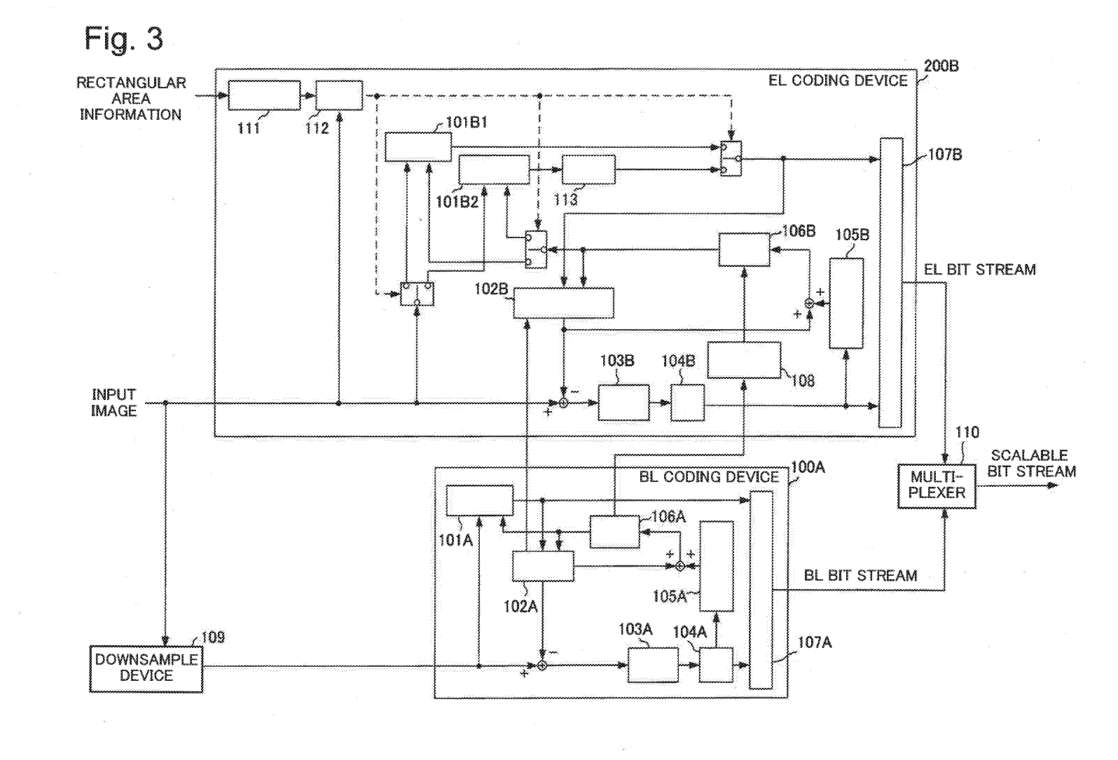

In order to more reliably ensure that the number of bits is minimized in the bit number preferential compression area, the video coding apparatus according to the second exemplary embodiment includes the encoder configuration as illustrated in FIG. 3. The video coding apparatus according to the second exemplary embodiment has a configuration of the video coding apparatus as illustrated in FIG. 1 and additionally having an AMVP estimation device 113.

FIG. 3 is a block diagram illustrating an example of a configuration of a video coding apparatus according to the second exemplary embodiment of the present invention. A configuration of a video coding apparatus according to the second exemplary embodiment outputting a bit stream by using each frame of a digitalized video as an input image will be explained with reference to FIG. 3.

The video coding apparatus according to the second exemplary embodiment uses means for generating a rectangular area which is of a multiple of a CTU size and which includes a rectangular area designated from an outside of the apparatus, so that a determination between an area where the compression is performed by giving precedence to the image quality and an area where the compression is performed by giving precedence to the number of bits becomes a CTU unit. The means for generating a rectangular area of a multiple of a CTU size corresponds to the CTU align coordinate transform device 111. As a result, the switching control of the compression processing preferable for each area is simplified. Further, with the means for determining the block division/block prediction parameter for the area where the compression is performed by giving precedence to the number of bits, the coding parameter of the minimum number of bits using the base layer is uniquely selected by making use of AMVP. Further, with the means for determining the block division/block prediction parameter, the amount of computation required for estimation of the coding parameter is greatly reduced, while the image quality is maintained at a certain level. This means for determining the block division/block prediction parameter corresponds to the bit number preferential estimation device 101B2 and the AMVP estimation device 113 explained later. As a result, the area where the compression is performed by giving precedence to the image quality can be compressed with a higher image quality by effectively making use of the number of bits and the amount of computation saved in the area where the compression is performed by giving precedence to the number of bits

The video coding apparatus as illustrated in FIG. 3 includes a BL coding device 100A, an EL coding device 200B, a downsample device 109, and a multiplexer 110.

The configuration of the BL coding device 100A is the same as the configuration of the first exemplary embodiment as illustrated in FIG. 1.

The EL coding device 200B has a configuration of the EL coding device 100B according to the first exemplary embodiment as illustrated in FIG. 1 and additionally having the AMVP estimation device 113.

The EL coding device 200B, which is a characteristic portion of the present exemplary embodiment, will be hereinafter explained.

The CTU align coordinate transform device 111 receives, as input, an upper left (x, y) coordinate and a lower right (x, y) coordinate of a rectangular area designated by the user as an image quality preferential area, and outputs the image quality preferential compression area. More specifically, the CTU align coordinate transform device 111 outputs, as an image quality preferential compression area, an upper left (x, y) coordinate and a lower right (x, y) coordinate including the image quality preferential area designated by the user and adjusted to a multiple of the maximum size of the CTU. For example, when the CTU is a multiple of 64, and the user inputs an upper left coordinate (x, y)=(4, 40) and a lower right coordinate (x, y)=(480, 320), the CTU align coordinate transform device 111 converts the input coordinates into an upper left coordinate (0, 0) and lower right coordinate (512, 320). Then, the CTU align coordinate transform device 111 outputs the converted coordinates (image quality preferential compression area).

The CTU determination device 112 receives, as input, the image quality preferential compression area which is output from the CTU align coordinate transform device 111 and the CTU of the current coding target. The CTU determination device 112 determines whether the CTU of the current coding target is included in the image quality preferential compression area or not, and outputs a control signal.

When the CTU of the current coding target is not included in the image quality preferential compression area, the CTU determination device 112 outputs a control signal for controlling switches so as to achieve (i), (ii), (iii) shown below.

(i) The bit number preferential estimation device 101B2 receives the CTU of the current coding target.

(ii) The output of the AMVP estimation device 113 is input into the prediction device 102B and the entropy coding device 107B.

(iii) The image quality preferential estimation device 101B2 can obtain, from the buffer 106B, data stored in the buffer 106B.

Then, the bit number preferential estimation device 101B2 and the AMVP estimation device 113 determine the following (A) to (C) for each CTU, so that, while the image quality of the CTU of the current coding target is maintained at a certain level, the number of bits is minimized, and the efficiency of the coding processing is enhanced.

(A) CU quad tree structure,

(B) PU block prediction parameter, and

(C) TU quad tree structure.

The bit number preferential estimation device 101B2 determines the CU quad tree structure so as to minimize the number of CUs into which the CTU of the current coding target is divided. For example, when the size of the CTU is 64×64, the bit number preferential estimation device 101B2 determines that the size of the CU is size of 64×64. More specifically, the bit number preferential estimation device 101B2 outputs split_cu_flag=0 indicating that any block division is not made.

The bit number preferential estimation device 101B2 determines the block division form in the PU block prediction parameter so as to minimize the number of bits of each CU. For example, the bit number preferential estimation device 101B2 determines that the division form of the PUs is 2N×2N, in which the number of divisions is small. Further, the bit number preferential estimation device 101B2 selects the inter-layer prediction rather than selecting the intra prediction so as to maintain a certain image quality in each PU. The parameter based on AMVP in the PU block prediction parameter is determined by the AMVP estimation device 113.

The AMVP estimation device 113 outputs a combination of the following (a) to (c) based on AMVP as a parameter based on AMVP of the PU block prediction parameter.

(a) a reference picture index associated with the base layer,

(b) an AMVP index associated with an AMVP prediction motion vector closest to a zero motion vector, and,

(c) a difference motion vector obtained by subtracting the AMVP prediction motion vector closest to the zero motion vector from the zero motion vector.

The bit number preferential estimation device 101B2 determines the TU quad tree structure so as to minimize the number of bits of the TU parameter of each CU. In other words, the bit number preferential estimation device 101B2 determines the TU parameter of the maximum size. More specifically, the bit number preferential estimation device 101B2 determines that split_transform_flag is any one of 0 and 1 in accordance with the size of each CU. For example, when the size of the CU is 64×64, the bit number preferential estimation device 101B2 determines that the TU parameter is 32×32 which is the maximum size. In other words, first, the bit number preferential estimation device 101B2 outputs split_transform_flag=1 indicating that a block division will be made, and outputs split_transform_flag=0 indicating that any block division will not be made in each TU having a size of 32×32.

The prediction device 102B outputs a prediction signal for the input image signal of the CU based on the following (1) or (2).

(1) The CU quad tree structure and the PU block prediction parameter determined by the image quality preferential estimation device 101B1.

(2) The CU quad tree structure determined by the bit number preferential estimation device 101B2, and the PU block prediction parameter determined by the bit number preferential estimation device 101B2 and the AMVP estimation device 113.

The prediction signal is generated based on the intra prediction, the inter prediction, or the inter-layer prediction described above.

The frequency transform device 103B performs frequency transform to transform the prediction error image obtained by subtracting the prediction signal from the input image signal based on the TU quad tree structure determined by the image quality preferential estimation device 101B1 or the bit number preferential estimation device 101B2. Then, the frequency transform device 103B outputs orthogonal transform coefficients (the frequency-transformed prediction error image).

The quantization device 104B quantizes the orthogonal transform coefficients. Then, the quantization device 104B outputs the coefficient levels.

The entropy coding device 107B performs entropy coding on split_cu_flag indicating the quad tree structure of the CU, the PU block prediction parameter, split_transform_flag indicating the quad tree structure of the TU, and coefficient levels. Then, the entropy coding device 107B outputs the EL bit stream.

The inverse frequency transform/inverse quantization device 105B performs inverse quantization on the coefficient levels. Then, the inverse frequency transform/inverse quantization device 105B performs inverse frequency transform on the orthogonal transform coefficients obtained through the inverse quantization, and outputs the restructured prediction error image.

The buffer 106B receives the image obtained by upsampling the restructured image of the BL and the signal obtained by adding the prediction signal to the restructured prediction error image, and stores them as the restructured image of the EL.

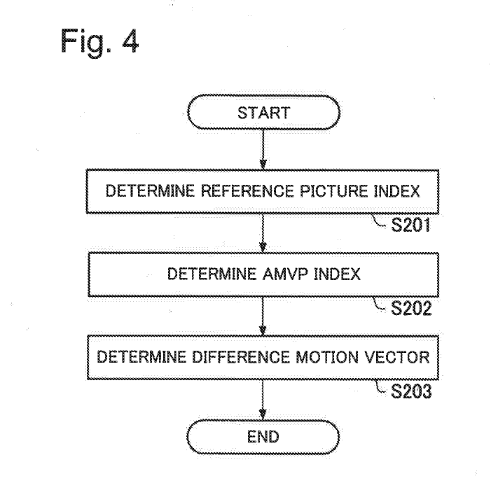

Subsequently, an operation of the EL coding device 200B will be explained. The operation of the EL coding device 200B is similar to the operation of the first exemplary embodiment except step S109. In the EL coding device 200B according to the present exemplary embodiment, the operation of the PU block prediction parameter determination in step S109 explained above is different from the operation of the EL coding device 100B. Accordingly, the operation of the AMVP estimation device 113 for determining the parameter based on AMVP in the PU block prediction parameter will be explained with reference to the flowchart as shown in FIG. 4.

The AMVP estimation device 113 determines the reference picture index associated with the base layer (step S201). Then, the AMVP estimation device 113 proceeds to the processing in step S202.

The AMVP estimation device 113 determines the AMVP index associated with the AMVP prediction motion vector closest to the zero motion vector (step S202). Then, the AMVP estimation device 113 proceeds to the processing in step S203.

The AMVP estimation device 113 determines the difference motion vector obtained by subtracting the AMVP prediction motion vector closest to the zero motion vector from the zero motion vector (step S203).

Then, the AMVP estimation device 113 determines a combination of the following (a) to (c) as a parameter based on AMVP of the PU block prediction parameter.

(a) a reference picture index associated with the base layer,

(b) an AMVP index associated with an AMVP prediction motion vector closest to a zero motion vector, and,

(c) a difference motion vector obtained by subtracting the AMVP prediction motion vector closest to the zero motion vector from the zero motion vector.

Then, the AMVP estimation device 113 terminates the processing for determining the parameter based on AMVP in the PU block prediction parameter.

### Third Exemplary Embodiment

The third exemplary embodiment of the present invention will be hereinafter explained with reference to drawings.

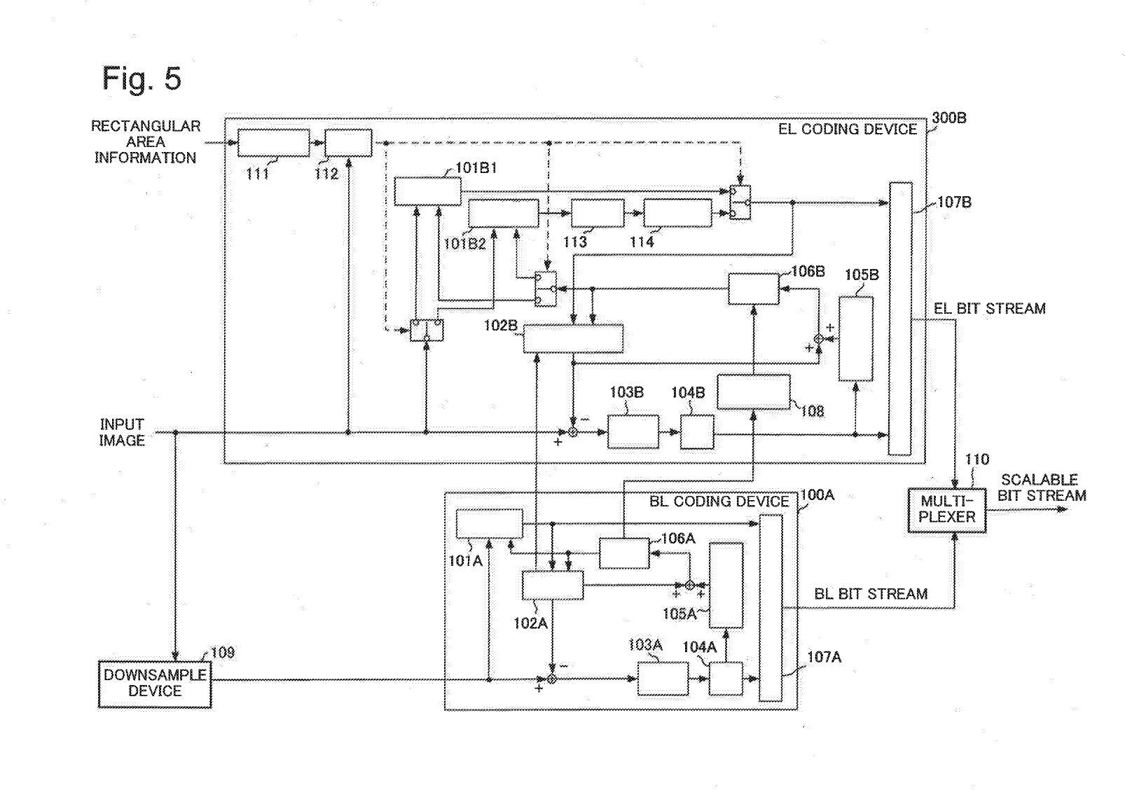

In order to more reliably ensure that the number of bits is minimized in the bit number preferential compression area than the second exemplary embodiment, the video coding apparatus according to the third exemplary embodiment includes an encoder configuration as shown in FIG. 5. The video coding apparatus according to the third exemplary embodiment has the configuration of the video coding apparatus as shown in FIG. 3 and additionally include a merge prediction estimation device 114.

FIG. 5 is a block diagram illustrating the configuration of the video coding apparatus according to the third exemplary embodiment of the present invention. The configuration of the video coding apparatus according to the third exemplary embodiment outputting a bit stream by using each frame of a digitalized video as an input image will be explained with reference to FIG. 5.

The video coding apparatus according to the third exemplary embodiment uses means for generating a rectangular area which is of a multiple of a CTU size and which includes a rectangular area designated from an outside of the apparatus, so that a determination between an area where the compression is performed by giving precedence to the image quality and an area where the compression is performed by giving precedence to the number of bits becomes a CTU unit. As a result, the switching control of the compression processing preferable for each area is simplified. The means for generating a rectangular area of a multiple of a CTU size corresponds to the CTU align coordinate transform device 111. Further, with the means for determining the block division/block prediction parameter for the area where the compression is performed by giving precedence to the number of bits, the coding parameter of the minimum number of bits using the base layer is uniquely selected by making use of the merge prediction. Further, with the means for determining the block division/block prediction parameter, the amount of computation required for estimation of the coding parameter is greatly reduced, while the image quality is maintained at a certain level. This means for determining the block division/block prediction parameter corresponds to the bit number preferential estimation device 101B2, the AMVP estimation device 113, and the merge prediction estimation device 114 explained later. As a result, the area where the compression is performed by giving precedence to the image quality can be compressed with a higher image quality by effectively making use of the number of bits and the amount of computation saved in the area where the compression is performed by giving precedence to the number of bits.

The video coding apparatus as illustrated in FIG. 5 includes a BL coding device 100A, an EL coding device 300B, a downsample device 109, and a multiplexer 110.

The configuration of the BL coding device 100A has the same configuration as the second exemplary embodiment as shown in FIG. 3.

The EL coding device 300B includes not only the configuration of the EL coding device 200B according to the second exemplary embodiment as shown in FIG. 3 but also the merge prediction estimation device 114.

The EL coding device 300B, which is a characteristic portion of the present exemplary embodiment, will be hereinafter explained.

The CTU align coordinate transform device 111 receives, as input, an upper left (x, y) coordinate and a lower right (x, y) coordinate of a rectangular area designated by the user as an image quality preferential area, and outputs the image quality preferential compression area. More specifically, the CTU align coordinate transform device 111 outputs, as an image quality preferential compression area, an upper left (x, y) coordinate and a lower right (x, y) coordinate including the image quality preferential area designated by the user and adjusted to a multiple of the maximum size of the CTU. For example, when the CTU is a multiple of 64, and the user inputs an upper left coordinate (x, y)=(4, 40) and a lower right coordinate (x, y)=(480, 320), the CTU align coordinate transform device 111 converts the input coordinates into an upper left coordinate (0, 0) and lower right coordinate (512, 320). Then, the CTU align coordinate transform device 111 outputs the converted coordinates (image quality preferential compression area).

The CTU determination device 112 receives, as input, the image quality preferential compression area which is output from the CTU align coordinate transform device 111 and the CTU of the current coding target. The CTU determination device 112 determines whether the CTU of the current coding target is included in the image quality preferential compression area or not, and outputs a control signal.

When the CTU of the current coding target is not included in the image quality preferential compression area, the CTU determination device 112 outputs a control signal for controlling switches so as to achieve (i), (ii), (iii) shown below.

(i) The bit number preferential estimation device 101B2 receives the CTU of the current coding target.

(ii) The output of the merge prediction estimation device 114 is input into the prediction device 102B and the entropy coding device 107B.

(iii) The image quality preferential estimation device 101B2 can obtain, from the buffer 106B, data stored in the buffer 106B.

Then, the bit number preferential estimation device 101B2, the AMVP estimation device 113, and the merge prediction estimation device 114 determine the following (A) to (C) for each CTU, so that, while the image quality of the CTU of the current coding target is maintained at a certain level, the number of bits is minimized, and the efficiency of the coding processing is enhanced.

(A) CU quad tree structure,

(B) PU block prediction parameter, and

(C) TU quad tree structure.

The bit number preferential estimation device 101B2 determines the CU quad tree structure so as to minimize the number of CUs into which the CTU of the current coding target is divided. For example, when the size of the CTU is 64×64, the bit number preferential estimation device 101B2 determines that the size of the CU is size of 64×64. More specifically, the bit number preferential estimation device 101B2 outputs split_cu_flag=0 indicating that any block division is not made.

The bit number preferential estimation device 101B2 determines the block division form in the PU block prediction parameter so as to minimize the number of bits of each CU. For example, the bit number preferential estimation device 101B2 determines that the division form of the PUs is 2N×2N, in which the number of divisions is small. Further, the bit number preferential estimation device 101B2 selects the inter-layer prediction rather than selecting the intra prediction so as to maintain a certain image quality in each PU. The parameter based on AMVP in the PU block prediction parameter is determined by the AMVP estimation device 113. The parameter based on the merge mode in the PU block prediction parameter is determined by the merge prediction estimation device 114.

The AMVP estimation device 113 outputs a combination of the following (a) to (c) based on AMVP as a parameter based on AMVP of the PU block prediction parameter.

(a) a reference picture index associated with the base layer,

(b) an AMVP index associated with an AMVP prediction motion vector closest to a zero motion vector, and,

(c) a difference motion vector obtained by subtracting the AMVP prediction motion vector closest to the zero motion vector from the zero motion vector.

When there exit both of the reference picture index associated with the base layer and the merge candidate index associated with the zero motion vector, the merge prediction estimation device 114 outputs a combination of the merge flag and the merge candidate index. This merge flag indicates that the merge prediction is effective. The obtaining unit 114 outputs the combination of the merge flag and the merge candidate index as a parameter based on the merge mode of the PU block prediction parameter.

The bit number preferential estimation device 101B2 determines the TU quad tree structure so as to minimize the number of bits of the TU parameter of each CU. In other words, the bit number preferential estimation device 101B2 determines the TU parameter of the maximum size. More specifically, the bit number preferential estimation device 101B2 determines that split_transform_flag is any one of 0 and 1 in accordance with the size of each CU. For example, when the size of the CU is 64×64, the bit number preferential estimation device 101B2 determines that the TU parameter is 32×32 which is the maximum size. In other words, first, the bit number preferential estimation device 101B2 outputs split_transform_flag=1 indicating that a block division will be made, and outputs split_transform_flag=0 indicating that any block division will not be made in each TU having a size of 32×32.

The prediction device 102B outputs a prediction signal for the input image signal of the CU based on the following (1) or (2).

(1) The CU quad tree structure and the PU block prediction parameter determined by the image quality preferential estimation device 101B1.

(2) The CU quad tree structure determined by the bit number preferential estimation device 101B2, and the PU block prediction parameter determined by the bit number preferential estimation device 101B2 and the AMVP estimation device 113, and the merge prediction estimation device 114.

The prediction signal is generated based on the intra prediction, the inter prediction, or the inter-layer prediction explained above.

The frequency transform device 103B performs frequency transform to transform the prediction error image obtained by subtracting the prediction signal from the input image signal based on the TU quad tree structure determined by the image quality preferential estimation device 101B1 or the bit number preferential estimation device 101B2. Then, the frequency transform device 103B outputs orthogonal transform coefficients (the frequency-transformed prediction error image).

The quantization device 104B quantizes the orthogonal transform coefficients. Then, the quantization device 104B outputs the coefficient levels.

The entropy coding device 107B performs entropy coding on split_cu_flag indicating the quad tree structure of the CU, the PU block prediction parameter, split_transform_flag indicating the quad tree structure of the TU, and coefficient levels. Then, the entropy coding device 107B outputs the EL bit stream.

The inverse frequency transform/inverse quantization device 105B performs inverse quantization on the coefficient levels. Then, the inverse frequency transform/inverse quantization device 105B performs inverse frequency transform on the orthogonal transform coefficients obtained through the inverse quantization, and outputs the restructured prediction error image.

The buffer 106B receives the image obtained by upsampling the restructured image of the BL and the signal obtained by adding the prediction signal to the restructured prediction error image as input, and stores them as the restructured image of the EL.

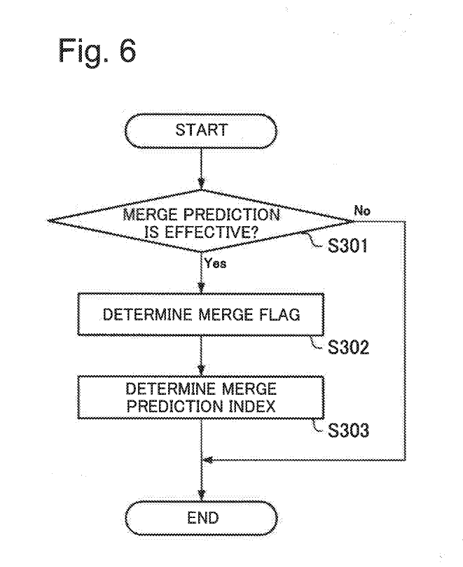

Subsequently, an operation of the EL coding device 300B will be explained. The operation of the EL coding device 300B is similar to the operation of the second exemplary embodiment except the operation of the PU block prediction parameter determination. Accordingly, the operation of the merge prediction estimation device 114 for determining the parameter based on the merge mode in the PU block prediction parameter will be explained with reference to the flowchart as shown in FIG. 6.

The merge prediction estimation device 114 executes the following processing in steps S301 to S303 after the AMVP estimation device 113 executes the processing in steps S201 to S203.

The merge prediction estimation device 114 confirms whether there exist the reference picture index associated with the base layer and the merge candidate index associated with the zero motion vector (step S301). When there exist the reference picture index and the merge candidate index, it is determined that the merge prediction is effective. When the merge prediction is effective (Yes in step S301), the merge prediction estimation device 114 proceeds to the processing in step S302. If not (No in step S301), the merge prediction estimation device 114 terminates the processing for determining the parameter based on the merge mode in the PU block prediction parameter.

The merge prediction estimation device 114 determines a merge flag indicating that the merge prediction is effective (step S302). Then, the merge prediction estimation device 114 proceeds to the processing in step S303.

The merge prediction estimation device 114 determines the merge candidate index associated with the zero motion vector, which is used for the merge prediction (step S303).

Then, the merge prediction estimation device 114 determines a combination of the merge flag indicating that the merge prediction is effective and the merge candidate index, as the parameter based on the merge mode in the PU block prediction parameter, and terminates the processing for determining the parameter based on the merge mode in the PU block prediction parameter.

### Fourth Exemplary Embodiment

The fourth exemplary embodiment of the present invention will be hereinafter explained with reference to drawings.

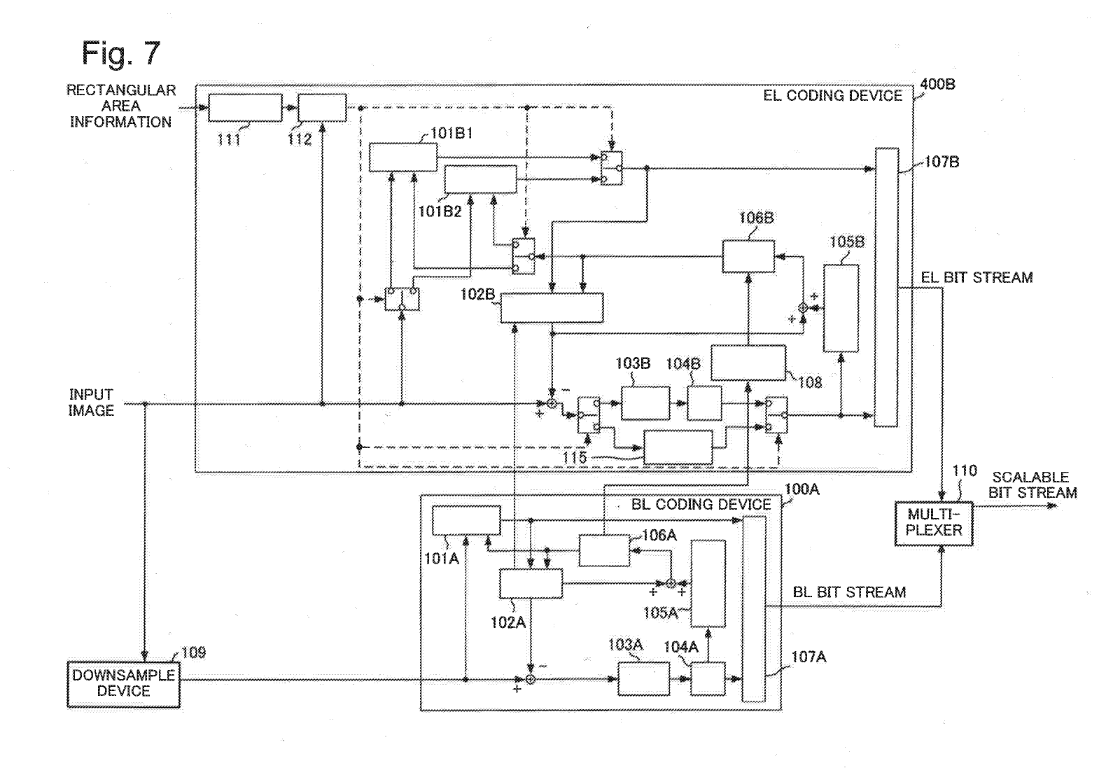

In order to more reliably ensure that the number of bits is minimized in the bit number preferential compression area than the first, second, or third exemplary embodiment, the video coding apparatus according to the fourth exemplary embodiment includes an encoder configuration as illustrated in FIG. 7. The video coding apparatus according to the fourth exemplary embodiment has the configuration of the video coding apparatus as shown in FIG. 1 and additionally include a prediction error cutoff device 115.

FIG. 7 is a block diagram illustrating an example of a configuration of the video coding apparatus according to the fourth exemplary embodiment of the present invention. The configuration of the video coding apparatus according to the fourth exemplary embodiment outputting a bit stream by using each frame of a digitalized video as an input image will be explained with reference to FIG. 7.

The video coding apparatus according to the fourth exemplary embodiment uses means for generating a rectangular area which is of a multiple of a CTU size and which includes a rectangular area designated from an outside of the apparatus, so that a determination between an area where the compression is performed by giving precedence to the image quality and an area where the compression is performed by giving precedence to the number of bits becomes a CTU unit. As a result, the switching control of the compression processing preferable for each area is simplified. The means for generating a rectangular area of a multiple of a CTU size corresponds to the CTU align coordinate transform device 111. Further, with the means for determining the block division/block prediction parameter for the area where the compression is performed by giving precedence to the number of bits, the coding parameter of the minimum number of bits using the base layer is selected uniquely. Further, with the means for determining the block division/block prediction parameter, the amount of computation required for estimation of the coding parameter is greatly reduced, while the image quality is maintained at a certain level. This means for determining the block division/block prediction parameter corresponds to the bit number preferential estimation device 101B2. Further, with prediction error cutoff means for forcibly making a prediction error signal be zero (corresponding to the prediction error cutoff device 115 explained later), the number of bits required for coding an area where the compression is performed by giving precedence to the number of bits is greatly reduced. As a result, an area where the compression is performed by giving precedence to the image quality can be compressed with a higher image quality by effectively making use of the number of bits and the amount of computation saved in the area where the compression is performed by giving precedence to the number of bits.

The video coding apparatus as shown in FIG. 7 includes a BL coding device 100A, an EL coding device 400B, a downsample device 109, and a multiplexer 110.

The configuration of the BL coding device 100A is similar to the configuration of the BL coding device 100A according to the first exemplary embodiment as shown in FIG. 1.

The EL coding device 400B includes not only the configuration of the EL coding device 100B according to the first exemplary embodiment as shown in FIG. 1 but also the prediction error cutoff device 115.

The EL coding device 400B, which is a characteristic portion of the present exemplary embodiment, will be hereinafter explained.

The CTU align coordinate transform device 111 receives, as input, an upper left (x, y) coordinate and a lower right (x, y) coordinate of a rectangular area designated by the user as an image quality preferential area, and outputs the image quality preferential compression area. More specifically, the CTU align coordinate transform device 111 outputs, as an image quality preferential compression area, an upper left (x, y) coordinate and a lower right (x, y) coordinate including the image quality preferential area designated by the user and adjusted to a multiple of the maximum size of the CTU. For example, when the CTU is a multiple of 64, and the user inputs an upper left coordinate (x, y)=(4, 40) and a lower right coordinate (x, y)=(480, 320), the CTU align coordinate transform device 111 converts the input coordinates into an upper left coordinate (0, 0) and lower right coordinate (512, 320). Then, the CTU align coordinate transform device 111 outputs the converted coordinates (image quality preferential compression area).

The CTU determination device 112 receives, as input, the image quality preferential compression area which is output from the CTU align coordinate transform device 111 and the CTU of the current coding target. The CTU determination device 112 determines whether the CTU of the current coding target is included in the image quality preferential compression area or not, and outputs a control signal.

When the CTU of the current coding target is not included in the image quality preferential compression area, the CTU determination device 112 outputs a control signal for controlling switches so as to achieve (i), (ii), (iii) shown below.

(i) The bit number preferential estimation device 101B2 receives the CTU of the current coding target.

(ii) The output of the bit number preferential estimation device 101B2 is input into the prediction device 102B and the entropy coding device 107B.

(iii) The image quality preferential estimation device 101B2 can obtain, from the buffer 106B, data stored in the buffer 106B.

Then, the bit number preferential estimation device 101B2 determines the CU quad tree structure, the PU block prediction parameter, and the TU quad tree structure for each CTU, so that, while the image quality of the CTU of the current coding target is maintained at a certain level, the number of bits is minimized, and the efficiency of the coding processing is enhanced.

The bit number preferential estimation device 101B2 determines the CU quad tree structure so as to minimize the number of CUs into which the CTU of the current coding target is divided. For example, when the size of the CTU is 64×64, the bit number preferential estimation device 101B2 determines that the size of the CU is size of 64×64. More specifically, the bit number preferential estimation device 101B2 outputs split_cu_flag=0 indicating that any block division is not made.

The bit number preferential estimation device 101B2 determines the block division form in the PU block prediction parameter so as to minimize the number of bits of each CU. For example, the bit number preferential estimation device 101B2 determines that the division form of the PUs is 2N×2N, in which the number of divisions is small. Further, the bit number preferential estimation device 101B2 selects the inter-layer prediction rather than selecting the intra prediction so as to maintain a certain image quality in each PU. It should be noted that the bit number preferential estimation device 101B2 according to the present exemplary embodiment has the functions of the AMVP estimation device 113 as shown in FIG. 3 and the merge prediction estimation device 114 as shown in FIG. 5. More specifically, in the present exemplary embodiment, the parameter based on the AMVP or the merge mode in the PU block prediction parameter is the following two.

The one is a combination of the following (a) to (c) determined based on the AMVP.

(a) a reference picture index associated with the base layer,

(b) an AMVP index associated with an AMVP prediction motion vector closest to a zero motion vector, and,

(c) a difference motion vector obtained by subtracting the AMVP prediction motion vector closest to the zero motion vector from the zero motion vector.

Another one is, when there exist a reference picture index associated with the base layer and a merge candidate index associated with the zero motion vector, a combination of the merge flag indicating that the merge prediction is effective and the merge candidate index.

The bit number preferential estimation device 101B2 determines the TU quad tree structure so as to minimize the number of bits of the TU parameter of each CU. In other words, the bit number preferential estimation device 101B2 determines the TU parameter of the maximum size. More specifically, the bit number preferential estimation device 101B2 determines that split_transform_flag is any one of 0 and 1 in accordance with the size of each CU. For example, when the size of the CU is 64×64, the bit number preferential estimation device 101B2 determines that the TU parameter is 32×32 which is the maximum size. In other words, first, the bit number preferential estimation device 101B2 outputs split_transform_flag=1 indicating that a block division will be made, and outputs split_transform_flag=0 indicating that any block division will not be made in each TU having a size of 32×32.

The prediction device 102B outputs a prediction signal for the input image signal of the CU based on the CU quad tree structure and the PU block prediction parameter determined by the image quality preferential estimation device 101B1 or the bit number preferential estimation device 101B2. The prediction signal is generated based on the intra prediction, the inter prediction, or the inter-layer prediction explained above.

The frequency transform device 103B performs frequency transform to transform the prediction error image obtained by subtracting the prediction signal from the input image signal based on the TU quad tree structure determined by the image quality preferential estimation device 101B1 or the bit number preferential estimation device 101B2. Then, the frequency transform device 103B outputs orthogonal transform coefficients (the frequency-transformed prediction error image).

The quantization device 104B quantizes the orthogonal transform coefficients. Then, the quantization device 104B outputs the coefficient levels.

The prediction error cutoff device 115 receives a prediction error signal as input, and forcibly makes a prediction error signal be zero and outputs the prediction error signal. More specifically, this processing is equivalent to making all the values of the coefficient levels received by the entropy coding device 107B to be zero.

The entropy coding device 107B performs entropy coding on split_cu_flag indicating the quad tree structure of the CU, the PU block prediction parameter, split_transform_flag indicating the quad tree structure of the TU, and coefficient levels. Then, the entropy coding device 107B outputs the EL bit stream.

The inverse frequency transform/inverse quantization device 105B performs inverse quantization on the coefficient levels. Then, the inverse frequency transform/inverse quantization device 105B performs inverse frequency transform on the orthogonal transform coefficients obtained through the inverse quantization, and outputs the restructured prediction error image.

The buffer 106B receives the image obtained by upsampling the restructured image of the BL and the signal obtained by adding the prediction signal to the restructured prediction error image, and stores them as the restructured image of the EL.

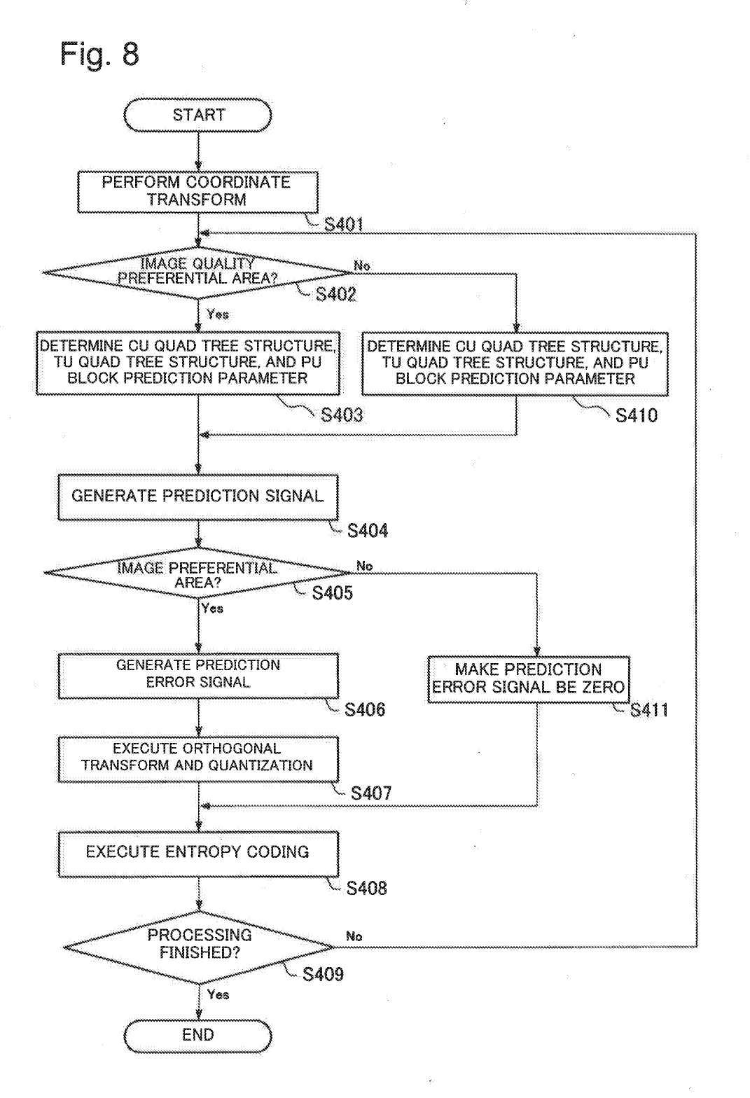

Subsequently, an operation (coding processing of the input image) of the EL coding device 400B performed on each CTU will be explained with reference to the flowchart as shown in FIG. 8.

The CTU align coordinate transform device 111 receives an upper left (x, y) coordinate and a lower right (x, y) coordinate of the rectangular area designated by the user as the image quality preferential area. Then, the CTU align coordinate transform device 111 outputs an upper left (x, y) coordinate and a lower right (x, y) coordinate including the image quality preferential area designated by the user and adjusted to a multiple of the maximum size of the CTU. For example, when the CTU is a multiple of 64, and the user inputs an upper left coordinate (x, y)=(4, 40) and a lower right coordinate (x, y)=(480, 320), the CTU align coordinate transform device 111 outputs coordinates of the upper left (0, 0) and the lower right (512, 320) (step S401). Then, the EL coding device 400B proceeds to the processing in step S402.

The CTU determination device 112 determines whether the CTU of the current coding target is included in the image quality preferential compression area or not (step S402). When the CTU of the current coding target is included in the image quality preferential compression area (Yes in step S402), the EL coding device 400B proceeds to the processing in step S403. When the CTU of the current coding target is not included in the image quality preferential compression area (No in step S402), the EL coding device 400B proceeds to the processing in step S410.

In a case of Yes in step S402, the image quality preferential estimation device 101B1 determines the CU quad tree structure, the PU block prediction parameter, and the TU quad tree structure (step S403). The CU quad tree structure is determined to minimize the rate distortion cost of the CU of the CTU of the current coding target. The PU block prediction parameter is determined to minimize the rate distortion cost of each CU. Further, the TU quad tree structure is determined to minimize the rate distortion cost of each CU. Then, the EL coding device 400B proceeds to the processing in step S404.

In a case of No in step S402, the bit number preferential estimation device 101B2 uniquely determines the CU quad tree structure, the PU block prediction parameter, and the TU quad tree structure (step S410). The CU quad tree structure is determined to minimize the number of CUs into which the CTU of the current coding target is divided. The PU block prediction parameter is determined to minimize the number of bits of the PU parameter in each CU. Further, the bit number preferential estimation device 101B2 selects the inter-layer prediction rather than selecting the intra prediction and the inter prediction so as to maintain a certain image quality in each PU. The TU quad tree structure is determined to minimize the number of bits of the TU parameter of each CU. More specifically, the bit number preferential estimation device 101B2 selects the TU parameter of the maximum size. Then, the EL coding device 400B proceeds to the processing in step S404.

After step S403 or step S410, the prediction device 102B generates and outputs a prediction signal based on the determined PU block prediction parameter (step S404). Then, the EL coding device 400B proceeds to the processing in step S405.

The EL coding device 400B determines whether the CTU of the current coding target of the CTU determination device 112 is included in the image quality preferential compression area or not (step S405). When the CTU of the current coding target of the CTU determination device 112 is included in the image quality preferential compression area (Yes in step S405), the EL coding device 400B proceeds to the processing in step S406. When the CTU of the current coding target of the CTU determination device 112 is not included in the image quality preferential compression area (No in step S405), the EL coding device 400B proceeds to step S411.

In a case of Yes in step S405, a prediction error image is generated by subtracting the prediction signal from the input image signal (step S406). At this occasion, the CTU determination device 112 of the EL coding device 400B outputs a control signal for performing control so that the prediction error signal is input into the frequency transform device 103B, and the output of the quantization device 104B is input into the inverse frequency transform/inverse quantization device 105B and the entropy coding device 107B. Accordingly, the prediction error image, which is a difference between the input image signal and the prediction signal, is input into the frequency transform device 103B. Then, the EL coding device 400B proceeds to the processing in step S407.

The frequency transform device 103B performs frequency transform to transform the prediction error image based on the determined TU quad tree structure. Then, the frequency transform device 103B outputs orthogonal transform coefficients (the frequency-transformed prediction error image). The quantization device 104B quantizes the orthogonal transform coefficients, and outputs the coefficient levels (step S407). Then, the EL coding device 400B proceeds to the processing in step S408.

In a case of No in step S405, the prediction error cutoff device 115 forcibly makes the prediction error signal be zero (step S411). At this occasion, the CTU determination device 112 of the EL coding device 400B outputs a control signal for performing control, so that the prediction error signal is input into the prediction error cutoff device 115, and the output of the prediction error cutoff device 115 is input into the inverse frequency transform/inverse quantization device 105B and the entropy coding device 107B. Then, the EL coding device 400B proceeds to the processing in step S408.

After step S407 or step S411 is finished, the entropy coding device 107B performs entropy coding on split_cu_flag indicating the quad tree structure of the CU, the PU block prediction parameter, split_transform_flag indicating the TU quad tree structure, and coefficient levels (step S408). Then, the entropy coding device 107B outputs an EL bit stream. Then, the EL coding device 400B proceeds to the processing in step S409.

The EL coding device 400B determines whether all the CTUs included in the input image have been processed or not (step S409). When the EL coding device 400B have processed all the CTUs (Yes in step S409), the EL coding device 400B terminates the coding processing of the input image. When the EL coding device 400B have not yet processed all the CTUs (No in step S409), the EL coding device 400B proceeds to the processing in step S402 in order to process a subsequent CTU.

In the present exemplary embodiment, for example, the bit number preferential estimation device 101B2 has the functions of the AMVP estimation device 113 and the merge prediction estimation device 114, but it is to be understood that the EL coding device 400B may have the AMVP estimation device 113 and the merge prediction estimation device 114. More specifically, it is to be understood that the EL coding device 200B according to the second exemplary embodiment or the EL coding device 300B according to the third exemplary embodiment may be configured to further include the prediction error cutoff device 115.

### Fifth Exemplary Embodiment

The fifth exemplary embodiment of the present invention will be hereinafter explained with reference to drawings.

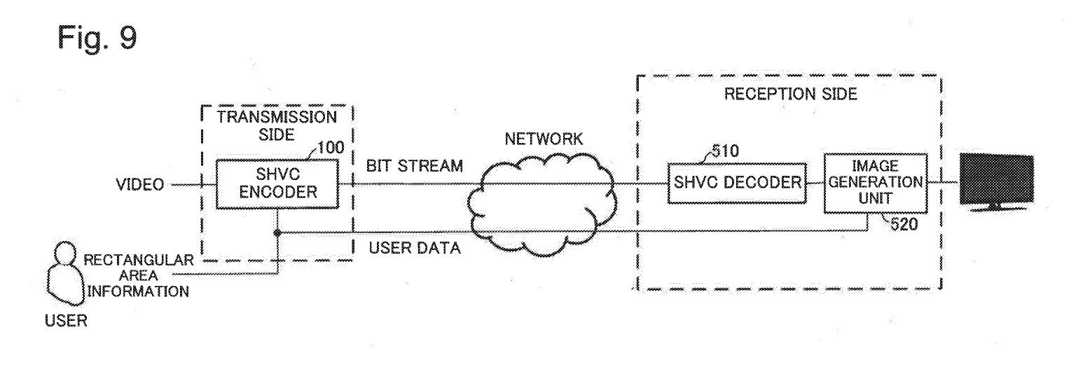

FIG. 9 is a block diagram illustrating an example of a configuration of a video transmission and reception system according to the fifth exemplary embodiment of the present invention. The configuration of the video transmission and reception system according to the fifth exemplary embodiment will be explained with reference to FIG. 9.

In the video transmission and reception system according to the fifth exemplary embodiment, an image generation unit (corresponding to an image generation unit 520 explained later) receiving rectangular area information designated from an outside can easily generate a video to be displayed having a higher image quality only in a rectangular area including rectangular area information while the image quality of the entire video is maintained at a certain level. Therefore, a reception side can perform display control so that a rectangular area included in a decoded video can be easily seen.

In the video transmission and reception system as shown in FIG. 9, the transmission side has an SHVC encoder 100, and the reception side has an SHVC decoder 510 and an image generation unit 520.

The SHVC encoder 100 has the configuration of the video coding apparatus according to the first, second, third, or fourth exemplary embodiment. The SHVC encoder 100 receives video and rectangular area information (which may be hereinafter also referred to as user data) that is input by the user at the transmission side. The SHVC encoder 100 compresses, with a higher image quality, an image quality preferential area designated by the user without increasing the amount of computation while the lowest image quality of the entire screen is maintained at a certain level, and outputs a bit stream.

The SHVC decoder 510 receives a bit stream, and outputs a decoded video. In this case, the SHVC decoder 510 receives a bit stream transmitted from the SHVC encoder 100 via a network.

The image generation unit 520 receives user data and the decoded video output from the SHVC decoder 510, and outputs a video to be displayed having a higher image quality only in a rectangular area corresponding to rectangular area information, the video to be displayed including the rectangular area information, while the image quality of the entire video is maintained at a certain level. In this case, the user data is transmitted to the image generation unit 520 via the network from the transmission side.

It is to be understood that the rectangular area information may be input from the user at the reception side.

### Sixth Exemplary Embodiment

The sixth exemplary embodiment of the present invention will be hereinafter explained with reference to drawings.

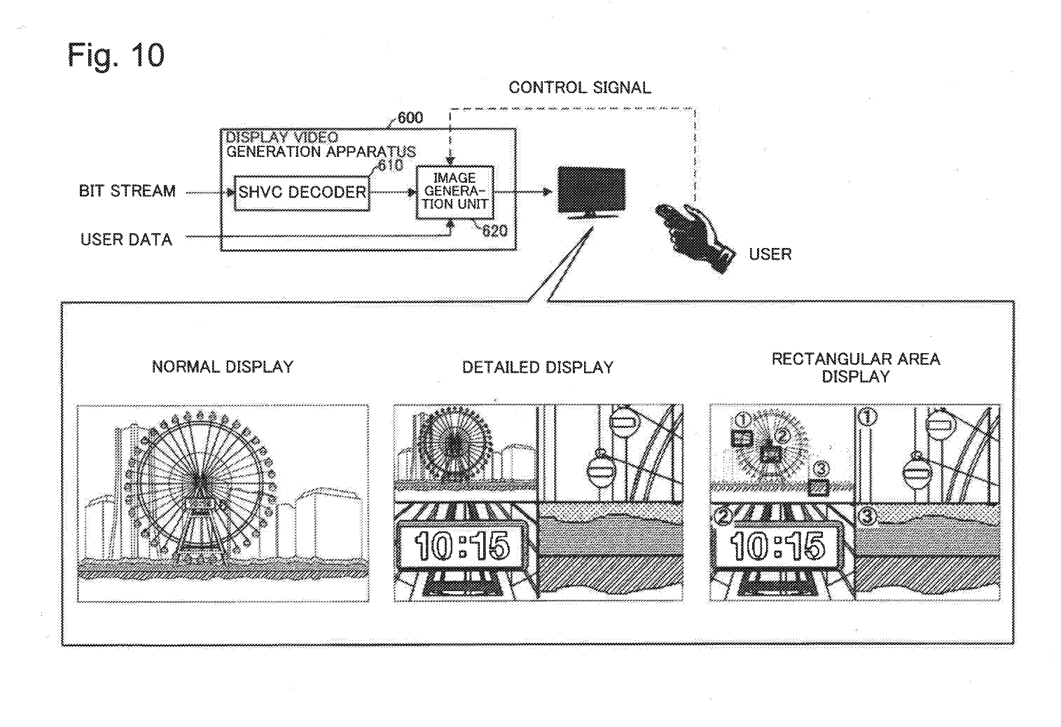

FIG. 10 is a block diagram illustrating an example of a configuration of a display video generation apparatus according to the sixth exemplary embodiment of the present invention. FIG. 10 illustrates an overview of the display video generation apparatus according to the sixth exemplary embodiment of the present invention. The configuration of the display video generation apparatus according to the sixth exemplary embodiment will be explained with reference to FIG. 10.

In the display video generation apparatus according to the sixth exemplary embodiment, an image generation unit (corresponding to an image generation unit 620 explained later) receiving a control signal transmitted from a user can easily display video in accordance with the needs of the user.

A display video generation apparatus 600 as illustrated in FIG. 10 includes an SHVC decoder 610 and an image generation unit 620.

The SHVC decoder 610 receives a bit stream, and outputs a decoded video.

The image generation unit 620 receives, as input, the decoded video that is output by the SHVC decoder 610, user data that is input by a user (for example, a user at the transmission side in the video transmission and reception system as shown in FIG. 9), and a control signal that is input by a user (for example, a user at the reception side in the video transmission and reception system as shown in FIG. 9). The image generation unit 620 outputs a video to be displayed. For example, as shown in FIG. 10, the control signal is input into the display video generation apparatus 600 when the user operates a remote controller and the like.

For example, when the user designates a normal display, the SHVC decoder 610 decodes only a base layer bit stream from a scalable bit stream. Then, the image generation unit 620 outputs, as a video to be displayed, a decoded video (video at the left side in FIG. 10) of a base layer bit stream enlarged to a display size to a display apparatus and the like.

For example, when the user designate detailed display, the SHVC decoder 610 decodes a base layer bit stream and an enhancement bit stream including a rectangular area designated by user data from a scalable bit stream. Then, the image generation unit 620 outputs, as a video to be displayed, a decoded video of the base layer bit stream and a decoded video (video in the center in FIG. 10) of the enhancement bit stream including the rectangular area to a display apparatus and the like.

For example, when the user designates a rectangular area display with a control signal, the image generation unit 620 outputs, as a video to be displayed, a decoded video (video at the right side of FIG. 10) on which the rectangular area is superimposed to a display apparatus and the like. In FIG. 10, the image generation unit 620 superimposes the rectangular area information on the decoded video of the base layer bit stream and the decoded video of the enhancement bit stream including the rectangular area, but the present exemplary embodiment is not limited thereto. The image generation unit 620 may superimpose the rectangular area information on the decoded video of the enhancement bit stream including the rectangular area based on the control signal, and may enlarge the decoded video, on which the rectangular area information is superimposed, to the display size, and display the decoded video.

It is to be understood that, in each of the above exemplary embodiments, there may be multiple pieces of rectangular area information designated from the outside.

Each of the above exemplary embodiments may be constituted by hardware, but each of the above exemplary embodiments may also be achieved with a computer program.

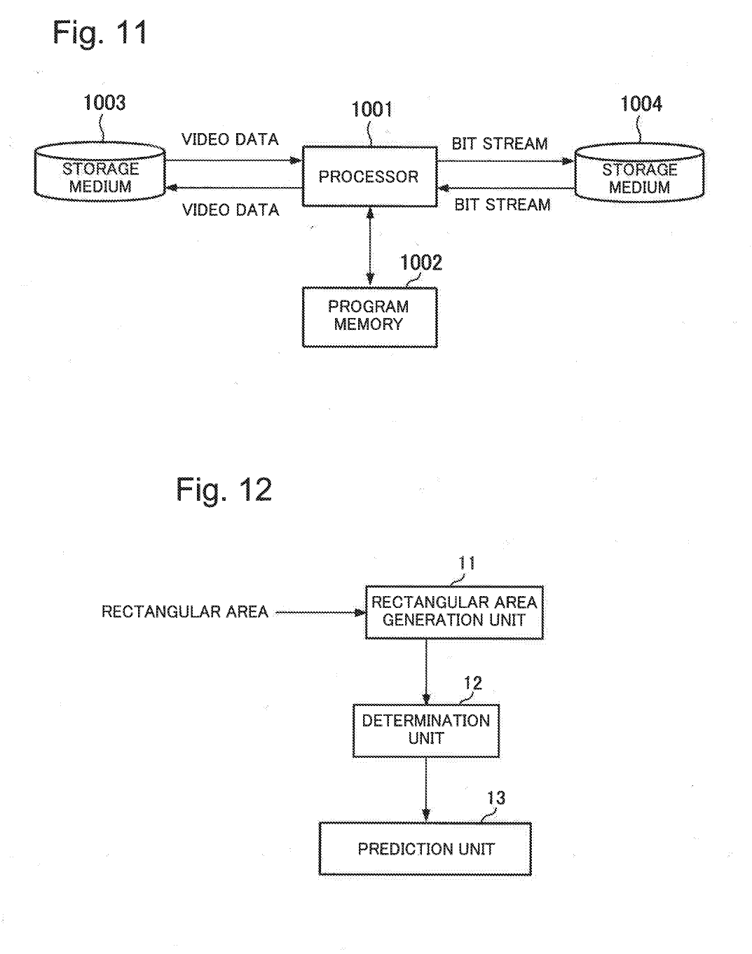

An information processing system as shown in FIG. 11 includes a processor 1001, a program memory 1002, a storage medium 1003 storing video data, and a storage medium 1004 storing a bit stream. The storage medium 1003 and the storage medium 1004 may be separate storage media, or may be a storage area made of the same storage medium. A magnetic storage medium such as a hard disk may be used as the storage medium.

In the information processing system as shown in FIG. 11, the program memory 1002 stores a program for realizing the function of each block (except a block of a buffer) shown in the drawing of each of the first, second, third, and fourth exemplary embodiments. The processor 1001 executes the processing in accordance with the program stored in the program memory 1002, so that the functions of the video coding apparatus shown in each of the above exemplary embodiments are achieved.

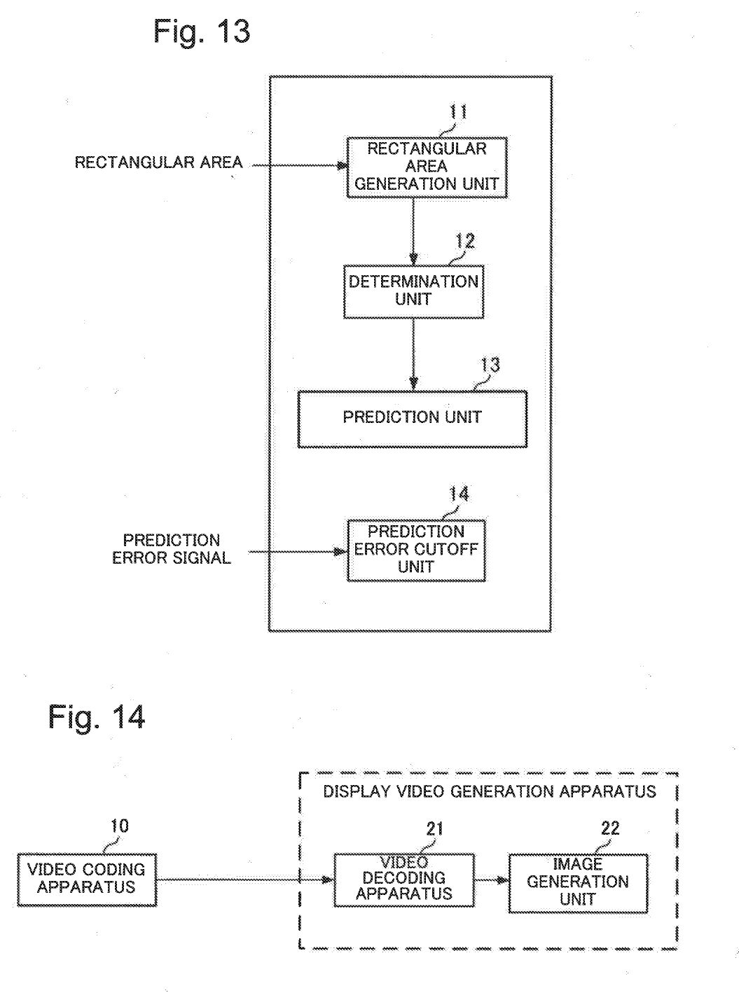

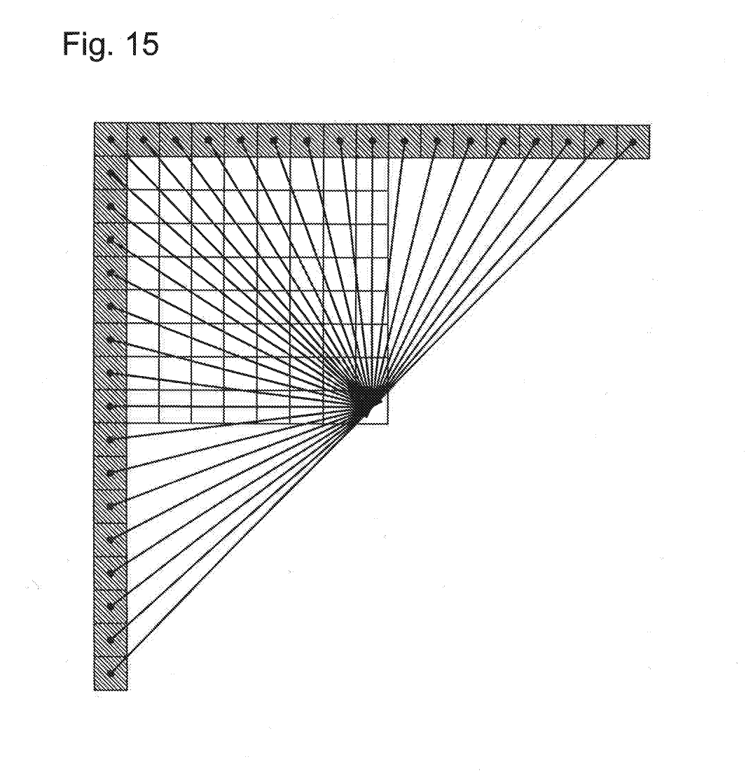

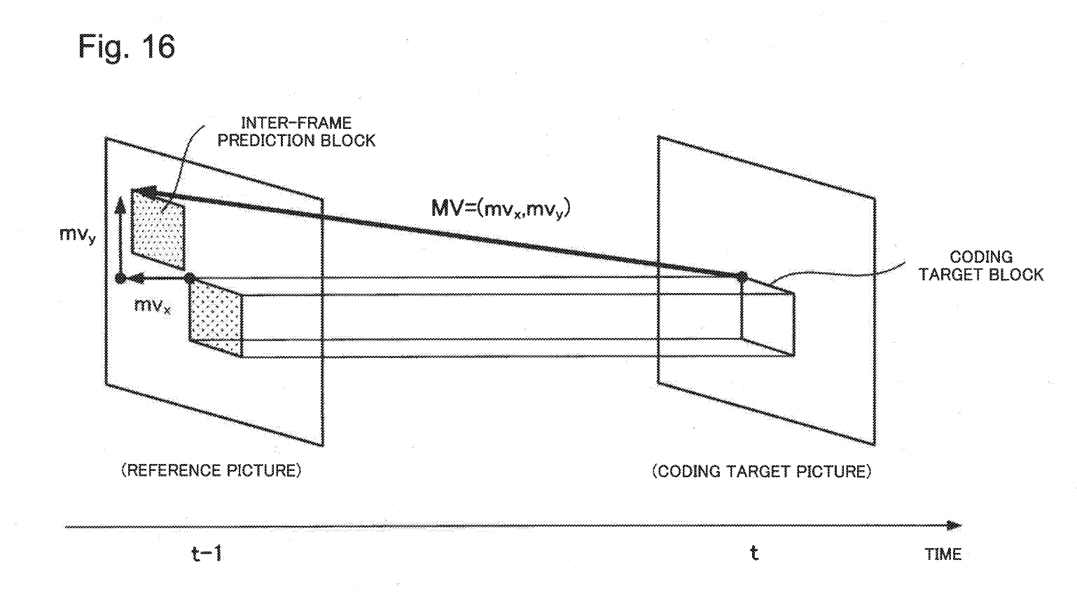

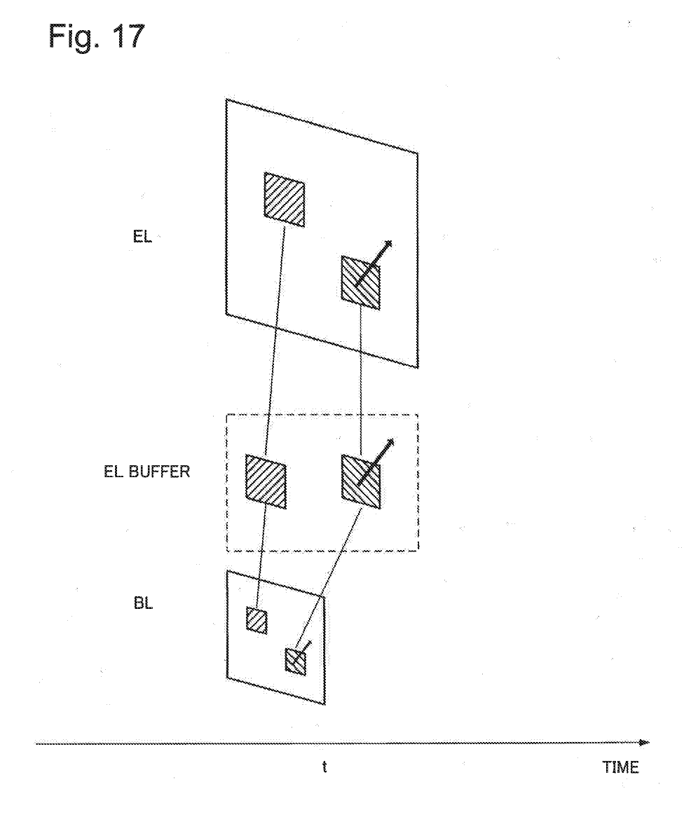

Subsequently, an overview of each exemplary embodiment of the present invention will be explained. FIG. 12 is a block diagram illustrating an example of a main portion of a video coding apparatus according to each exemplary embodiment of the present invention. FIG. 13 is a block diagram illustrating a main portion of another video coding apparatus according to each exemplary embodiment of the present invention.

As shown in FIG. 12, the video coding apparatus according to each exemplary embodiment of the present invention is a video coding apparatus outputting a scalable bit stream obtained by multiplexing a base layer bit stream in which a low resolution image obtained by downsampling an input image is coded as a base layer and an enhancement layer bit stream in which the input image is coded as an enhancement layer. The video coding apparatus includes a rectangular area generation unit 11, a determination unit 12, and a prediction unit 13.

The rectangular area generation unit 11 generates a rectangular area which is of a multiple of a CTU size and which includes a particular rectangular area. An example of the rectangular area generation unit 11 includes the CTU align coordinate transform device 111 as shown in FIG. 1.

The determination unit 12 determines whether the CTU of the coding target is included in a rectangular area of a multiple of a CTU size. An example of the determination unit 12 includes the CTU determination device 112 as shown in FIG. 1.

When the CTU of the coding target is not included in the rectangular area of the multiple of a CTU size, the prediction unit 13 divides the CTU of the coding target by the minimum number of CU blocks, and further, predicts each of obtained CUs with a prediction signal of the zero motion vector from the base layer. An example of the prediction unit 13 includes the bit number preferential estimation device 101B2 as shown in FIG. 1. Another example of the prediction unit 13 includes the bit number preferential estimation device 101B2 and the AMVP estimation device 113 as shown in FIG. 3. Or, another example of the prediction unit 13 includes the bit number preferential estimation device 101B2, the AMVP estimation device 113, and the merge prediction estimation device 114 as shown in FIG. 5.

According to such configuration, a determination between an area where the compression is performed by giving precedence to the image quality and an area where the compression is performed by giving precedence to the number of bits becomes a CTU unit, and the switching control of the compression processing preferable for each area is simplified. Further, the coding parameter of the minimum number of bits using the base layer is selected uniquely, and the amount of computation required for estimation of the coding parameter is greatly reduced, while the image quality is maintained at a certain level. As a result, the video coding apparatus can compress, with a higher image quality, an area where the compression is performed by giving precedence to the image quality by effectively making use of the number of bits and the amount of computation saved in the area where the compression is performed by giving precedence to the number of bits.

The prediction unit 13 may determine that a combination of the following (1) to (3) is a parameter based on AMVP in the block prediction parameter.

(1) a reference picture index associated with base layer prediction,

(2) an AMVP index associated with an AMVP prediction motion vector closest to a zero motion vector, and,

(3) a difference motion vector obtained by subtracting the AMVP prediction motion vector closest to the zero motion vector from the zero motion vector.

According to such configuration, in the bit number preferential compression area, the number of bits can be more reliably ensured to be minimum.

When there exist the reference picture index associated with the base layer prediction and the merge candidate index associated with the zero motion vector, the prediction unit 13 may determine the merge flag and the merge candidate index as a parameter. This merge flag indicates that the merge prediction is effective. The parameter determined by the prediction unit 13 is the parameter based on the merge mode in the block prediction parameter. According to such configuration, in the bit number preferential compression area, the number of bits can be more reliably ensured to be minimum.

As shown in FIG. 13, the video coding apparatus may include a prediction error cutoff unit 14 (for example, the prediction error cutoff device 115 as shown in FIG. 7) forcibly makes a prediction error signal be zero in a CTU not included in a rectangular area of a multiple of a CTU size. According to such configuration, in the bit number preferential compression area, the number of bits can be more reliably ensured to be minimum.

The above exemplary embodiment also discloses the following video transmission and reception system. FIG. 14 is a block diagram illustrating a main portion of a video transmission and reception system according to each exemplary embodiment of the present invention. As shown in FIG. 14, the video transmission and reception system includes a video coding apparatus 10, a video decoding apparatus 21, and an image generation unit 22. An example of the video coding apparatus 10 includes the video coding apparatus as shown in FIG. 1, 2, 3, or 4. The video decoding apparatus 21 receives and decodes a scalable bit stream that is output by the video coding apparatus 10. An example of the video decoding apparatus 21 includes an SHVC decoder 510 as shown in FIG. 9 or an SHVC decoder 610 as shown in FIG. 10. The image generation unit 22 generates an image including a decoded image and rectangular area information indicating a particular rectangular area. An example of the image generation unit 22 includes an image generation unit 520 as shown in FIG. 9 or an image generation unit 620 as shown in FIG. 10.

The above exemplary embodiment also discloses the following display video generation apparatus. As shown in FIG. 14, the display video generation apparatus according to each exemplary embodiment of the present invention is a display video generation apparatus generating a video to be displayed based on a decoded video of a scalable bit stream and rectangular area information, and includes a video decoding apparatus 21 and an image generation unit 22.

When the user designates normal display, the video decoding apparatus 21 decodes a base layer bit stream from the scalable bit stream, and the image generation unit 22 generates a video to be displayed of a base layer bit stream enlarged to a display size.

When the user designate detailed display, the video decoding apparatus 21 decodes a base layer bit stream and an enhancement layer bit stream including a rectangular area from a scalable bit stream. The image generation unit 22 generates a decoded video of the base layer bit stream and a decoded video of the enhancement layer bit stream including the rectangular area.

When the user designates a rectangular area display, the image generation unit 22 superimposes the rectangular area on the decoded video.

The invention of the present application has been hereinabove explained with reference to the exemplary embodiments, but the invention of the present application is not limited to the above exemplary embodiments. Various changes that can be understood by a person skilled in the art within the scope of the invention of the present application can be applied to the configuration and the details of the invention of the present application.

This application claims the priority based on Japanese Patent Application No. 2014-121635 filed on Jun. 12, 2014, and the entire disclosure thereof is incorporated herein by reference.

### REFERENCE SIGNS LIST

10 video coding apparatus
11 rectangular area generation unit
12 determination unit
13 prediction unit
14 prediction error cutoff unit
21 video decoding apparatus
22 image generation unit
100 SHVC encoder
100A, 900A BL coding device
100B, 200B, 300B, 400B, 900B EL coding device
101A, 901A, 901B estimation device
102A, 102B, 902A, 902B prediction device
103A, 103B, 903A, 903B frequency transform device
104A, 104B, 904A, 904B quantization device
105A, 105B, 905A, 905B inverse frequency transform/inverse quantization device
106A, 106B, 906A, 906B buffer
107A, 107B, 907A, 907B entropy coding device
108, 908 upsample device
109, 909 downsample device
111 CTU align coordinate transform device
112 CTU determination device
113 AMVP estimation device
114 merge prediction estimation device
115 prediction error cutoff device
101B1 image quality preferential estimation device
101B2 bit number preferential estimation device
510, 610 SHVC decoder
520, 620 image generation unit
1001 processor
1002 program memory
1003, 1004 storage medium

What is claimed is:

1. A video coding apparatus for outputting a scalable bit stream obtained by multiplexing a base layer bit stream in which a low resolution image obtained by downsampling an input image is coded as a base layer and an enhancement layer bit stream in which the input image is coded as an enhancement layer,
the video coding apparatus comprising:
a rectangular area generation unit configured to generate a rectangular area that is of a multiple of a CTU (Coding Tree Unit) size and includes a particular rectangular area;
a determination unit configured to determine whether a CTU of a coding target is included in the rectangular area of the multiple of the CTU size; and
a prediction unit configured to, when the CTU of the coding target is not included in the rectangular area of the multiple of the CTU size, divide the CTU of the coding target by a minimum number of CU blocks, and predict each of obtained CUs with a prediction signal of a zero motion vector from the base layer.

2. The video coding apparatus according to claim 1,
wherein the prediction means includes a combination of a reference picture index, an AMVP index, and a difference motion vector in block prediction parameters, the reference picture index being associated with a base layer prediction, the AMVP index being associated with an AMVP prediction motion vector closest to the zero motion vector, the difference motion vector being obtained by subtracting the AMVP prediction motion vector closest to the zero motion vector from the zero motion vector.

3. The video coding apparatus according to claim 1,
wherein the prediction means includes a merge flag indicating that the merge prediction is effective and a merge candidate index in block prediction parameters when a reference picture index and the merge candidate index are present, the reference picture index being associated with the base layer prediction and the merge candidate index being associated with the zero motion vector.

4. The video coding apparatus according to claim 1, further comprising prediction error cutoff unit configured to forcibly make a prediction error signal be zero in a CTU not included in the rectangular area of the multiple of the CTU size.

5.-6. (canceled)

7. A video coding method in a video coding apparatus for outputting a scalable bit stream obtained by multiplexing a base layer bit stream in which a low resolution image obtained by downsampling an input image is coded as a base layer and an enhancement layer bit stream in which the input image is coded as an enhancement layer,
the video coding method comprising:
generating a rectangular area that is of a multiple of a CTU size, including a particular rectangular area;
determining whether a CTU of a coding target is included in the rectangular area of the multiple of the CTU size; and
when the CTU of the coding target is not included in the rectangular area of the multiple of the CTU size, dividing the CTU of the coding target by a minimum number of CU blocks, and predicting each of obtained CUs with a prediction signal of a zero motion vector from the base layer.

8. A computer-readable non-transitory recording medium storing a video coding program for a computer in a video coding apparatus for outputting a scalable bit stream obtained by multiplexing a base layer bit stream in which a low resolution image obtained by downsampling an input image is coded as a base layer and an enhancement layer bit stream in which the input image is coded as an enhancement layer,
the video coding program causing the computer to execute:
processing of generating a rectangular area, that is of a multiple of a CTU size, including a particular rectangular area;
processing of determining whether a CTU of a coding target is included in the rectangular area of the multiple of the CTU size; and
processing of, when the CTU of the coding target is not included in the rectangular area of the multiple of the CTU size, dividing the CTU of the coding target by a minimum number of CU blocks, and predicting each of obtained CUs with a prediction signal of a zero motion vector from the base layer.
